(19) United States
(12) Patent Application Publication
(10) Pub. No.: US 2003/0233250 A1
(43) Pub. Date: Dec. 18, 2003

(54) Systems and methods for managing biological data and providing data interpretation tools

(76) Inventors: David Joffe, Boulder, CO (US); Vincent J. Colwell, Martinez, GA (US); Michael Peter Hickey, Boulder, CO (US); Steven M. Snyder, Boulder, CO (US); Stephen N. Xenakis, Augusta, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/368,295

(22) Filed: Feb. 18, 2003

Related U.S. Application Data
(60) Provisional application No. 60/358,477, filed on Feb. 19, 2002.

(51) Int. Cl. G06F 17/60

(52) U.S. Cl. 705/2

(57) ABSTRACT

The invention includes systems and methods for managing a patient's biological data and providing a data interpretation tool for the biological data via a network. An exemplary system and method includes collecting biological data from a patient; transmitting a portion of the biological data through the network to a storage device; determining at least one potential indicator variable associated with the patient's biological data; comparing the at least one potential indicator variable associated with the patient's biological data to a standardized set of data associated with a health condition; based upon the comparison, selecting at least one indicator variable; and generating a report including the indicator variable and at least one data interpretation tool to a health care provider associated with the patient.

### RELATED APPLICATIONS

This application claims priority to U.S. Provisional Patent Application No. 60/358,477, filed Feb. 19, 2002, the contents of which are incorporated herein by reference.

### FIELD OF THE INVENTION

This invention is directed to systems and methods that facilitate the interpretation of biological data, and more precisely relates to a network-based process to handle biological data and provide data interpretation tools presented in a report format with which a health care provider may characterize a patient's condition.

### BACKGROUND OF THE INVENTION

In a traditional health care setting, health care has been administered to patients by health care professionals in a one-on-one, personalized manner, such as an appointment with a doctor at the doctor's office, or a visit by a doctor to the patient's home. This type of attention to the specific health care needs of the patient provided the doctor with direct access to the patient to diagnose a patient's symptoms. In turn, the patient could discuss his or her health care directly with the doctor, such as asking questions related to one or more general or specific symptoms, or to a specific prescribed treatment.

Recent increases in the health care costs have placed a significant burden on patients as well as on health care providers to control expenses. Managed health care systems and other methods have been instituted in attempt to control health care costs, and to administer the resources of health care professionals. In many instances under these types of systems and methods, a personal appointment with a doctor at the doctor's office, or a visit by a doctor to the patient's home is financially expensive for the patient, especially for minor or non-life threatening symptoms. In these instances, the patient may decide not to schedule an appointment or visit by the doctor due to the cost of such treatment or care. Sometimes, if the patient goes untreated, this could lead to the lack of treatment or delay in treatment of a long-term health problem or disease. In an era where early diagnosis and prevention of diseases is encouraged by many health care professionals, the high costs of professional health care may actually discourage early diagnosis and prevention of diseases.

Circumstances involving chronic disease conditions can further increase costs, and burdens on the patient, health care professional, and health care system. Chronic disease management protocols are focused on meeting the needs of an average or mean patient condition and does relatively little or nothing to account for variations or complication co-morbidities. Patients with chronic disease conditions can experience expensive acute episodes, sometimes life threatening, that may not be readily identified by even health care professionals. In any event, conventional systems and methods do not provide professional health care professionals a presence in the patient's home, or sufficient patient status information in the health care professional's environment.

Another burden on managed health care systems and other methods is the increase in population relative to the number of trained health care professionals. For instance, an increased number of patients per doctor decreases the time that a doctor can spend with each patient, and increases the possibility of misdiagnosis and/or patient mortality. Less time with each patient means less attention to particular patients who may not have serious or life-threatening symptoms. Biological data that a doctor collects from a particular patient may not be monitored or tracked on a regular basis such that it might be correlated into useful information. Further, due to the time constraints placed on doctors in these situations, a particular doctor may not have the specialized resources or up-to-date knowledge to provide the best available health care to the patient.

Moreover, the knowledge and data that a doctor can collect from his patients about their health status could be helpful to other doctors treating other patients with similar symptoms. Typically, time consuming and costly research and analysis are needed to collect this knowledge and data from the doctors and patients. Resulting conclusions and improvements to health care treatments and decisions can take years to determine under these circumstances.

Conventional systems and methods exist for collecting biological data in an in-home or remote environment. However, these attempts merely collect and transmit biological data, sometimes only a single parameter, to a central location. At most, these systems and methods could be used to monitor biological data; however, without correlation to other biological parameters cannot provide a pertinent picture of the health status of the patient. These systems and methods do not provide any data processing to evaluate the biological data, or to make a diagnosis of the patient associated with the data.

Therefore, a need exists for systems and methods for managing and analyzing biological data that assist a user in evaluating a patient's biological data, systems and methods for providing data from a remote location to users, and systems and methods for determining and optimizing indicator variables associated with a patient's health. Systems and methods that provide feedback to a data collection device based upon the evaluation of a patient's biological data are also needed.

### SUMMARY OF THE INVENTION

Systems and processes according to various aspects and embodiments according to the invention address some or all of these issues and combinations of them. They do so by providing at least one method for managing a patient's biological data and providing a data interpretation tool for the biological data via a network. The method includes collecting biological data from a patient; transmitting a portion of the biological data through the network to a storage device; determining at least one potential indicator variable associated with the patient's biological data; comparing the at least one potential indicator variable associated with the patient's biological data to a standardized set of data associated with a health condition; based upon the comparison, selecting at least one indicator variable; and generating a report including the indicator variable and at least one data interpretation tool to a health care provider associated with the patient.

One aspect of systems and processes according to various embodiments of the invention, focuses on a method for determining an indicator variable for a patient's health condition. The method includes receiving biological data from a patient; artifacting the patient's biological data; applying an analytical tool to the patient's biological data to determine at least one potential indicator variable; comparing at least one potential indicator variable to at least one predetermined indicator associated with a health condition; and based upon the comparison, selecting an indicator variable to characterize the patient's health condition.

Another aspect of systems and processes according to various embodiments of the invention, focuses on a method for managing research data for comparison with collected biological data of a patient. The method includes selecting a health condition; receiving research from at least one data source, wherein the research is associated with the health condition; analyzing the research to determine at least one aspect of the health condition; and characterizing the aspect of the health condition with at least one indicator, wherein the indicator can be compared with at least one potential indicator variable associated with a particular patient's biological data.

Yet another aspect of systems and processes according to various embodiments of the invention, focuses on a system for managing a patient's biological data and providing a data interpretation tool for the biological data via a network. The system includes a data collection module, including a biological data collector adapted to collect biological data from a patient. The system also includes a network interface adapted to receive biological data from the data collector, and further adapted to transmit the biological data via the network to a storage device. Further, the system includes a report generation module including a processor-based device adapted to receive the patient's biological data from the biological data collector; to determine at least one potential indicator variable from a portion of the patient's biological data; to compare the biological data to a standardized set of data associated with a health condition; to select at least one potential indicator; to generate a data interpretation tool adapted to analyze the selected indicator variable; and to transmit a report with the data interpretation tool and selected indicator to a user via the network; and a storage device adapted to store the patient's biological data, potential indicator variables, and any selected indicator variables.

Another aspect of systems and processes according to various embodiments of the invention, focuses on a system for determining an indicator variable for a patient's health condition. The system includes a research analysis module including a processor adapted to collect relevant research for at least one health condition; and to determine at least one indicator for the health condition. Further, the system includes a report generation module including a processor adapted to receive biological data from a patient; artifact the patient's biological data; to apply an analytical tool to the patient's biological data to determine at least one potential indicator variable; to compare at least one potential indicator variable to the predetermined indicator associated with the health condition; and based upon the comparison, to select at least one indicator variable to characterize the patient's health condition.

Objects, features and advantages of various systems and processes according to various embodiments of the present invention include:

(1) Systems and methods for managing a patient's biological data and providing a data interpretation tool for the biological data via a network;

(2) Systems and methods for determining an indicator variable for a patient's health condition;

(3) Systems and methods for managing research data for comparison with collected biological data of a patient;

(4) Systems and methods for managing and analyzing biological data that assist a user in evaluating a patient's biological data;

(5) Systems and methods for providing data from a remote location to users;

(6) Systems and methods for determining and optimizing indicator variables associated with a patient's health; and

(7) Systems and methods for providing feedback to a data collection device based upon the evaluation of a patient's biological data.

Other objects, features and advantages will become apparent with respect to the remainder of this document.

### BRIEF DESCRIPTION OF THE DRAWINGS

FIG. 1 is a block diagram illustrating a report production process to evaluate biological data to address specific conditions of a patient.

FIG. 2 is a block diagram illustrating the pathways by which sources of information are brought into an evaluation scheme for the production of data interpretation tools.

FIG. 3 is a functional block diagram that illustrates an exemplary system in accordance with various embodiments of the invention.

FIG. 4 is a functional block diagram that illustrates another exemplary data collection system module in accordance with various embodiments of the invention.

FIG. 5 is a functional block diagram that illustrates component modules for an exemplary website and management application program module illustrated in FIG. 3.

FIG. 6 is a flowchart that illustrates an exemplary method in accordance with various embodiments of the invention.

FIG. 7 is a flowchart that illustrates an exemplary subroutine of the method in FIG. 6.

FIG. 8 is a flowchart that illustrates another exemplary subroutine of the method in FIG. 6.

FIG. 9 is a flowchart that illustrates another exemplary method in accordance with various embodiments of the invention.

FIGS. 10A-10B illustrate an exemplary report generated in accordance with various embodiments of the invention.

FIG. 11 illustrates another exemplary method in accordance with various embodiments of the invention.

### DETAILED DESCRIPTION OF SPECIFIC EMBODIMENTS

The present invention is directed to systems and processes for acquiring biological data, such data can be acquired from humans, animals or other biological organisms, processing the data, and using the data.

Terminology:

Before describing the drawings and exemplary embodiments in more detail, several terms are described below in an effort to clarify the terminology used in this document. Additional and fuller understanding of these terms will be clear upon reading this entire document:

Biological Data: Any data collected from a patient using invasive or non-invasive procedures. Invasive procedures can include, but are not limited to, blood samples and biopsies, and the like. Non-invasive procedures can include, but are not limited to, blood pressure readings, temperature readings, weight measurements, electrocardiograms (ECGs), electroencephalograms (EEGs), and the like.

Demographic Data: Data collected from a patient that generally describes the patient. Demographic data can include, but is not limited to, age, ethnicity, gender, birthplace, current address, education, and the like.

Indicator: A characteristic that identifies a particular aspect of a condition, healthy or pathological condition. An indicator, also known as an “indicator variable,” provides, or otherwise can be combined with research or other data to provide, context to a biological measurement and facilitates interpretation of the biological measurement with respect to a particular condition. Typically, an indicator is researched, verified, and tested to be a generally reliable, repeatable, or statistically significant characteristic for a particular aspect of a condition.

Health Condition: A physical or mental condition of a patient including, but not limited to, healthy or less than healthy conditions, chronic or acute conditions comprising healthy or less than healthy conditions, one or more disorders, complexes, diseases, infections, birth defects, accident sequella, or pathologically-related problems or afflictions.

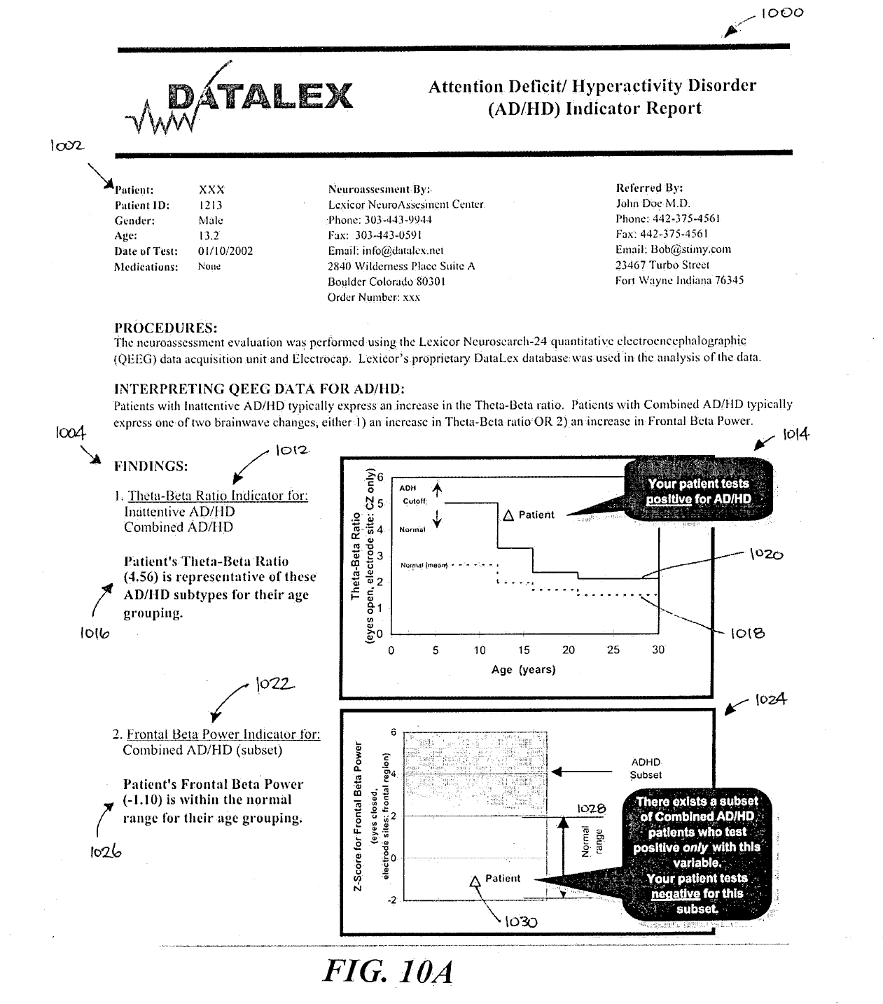

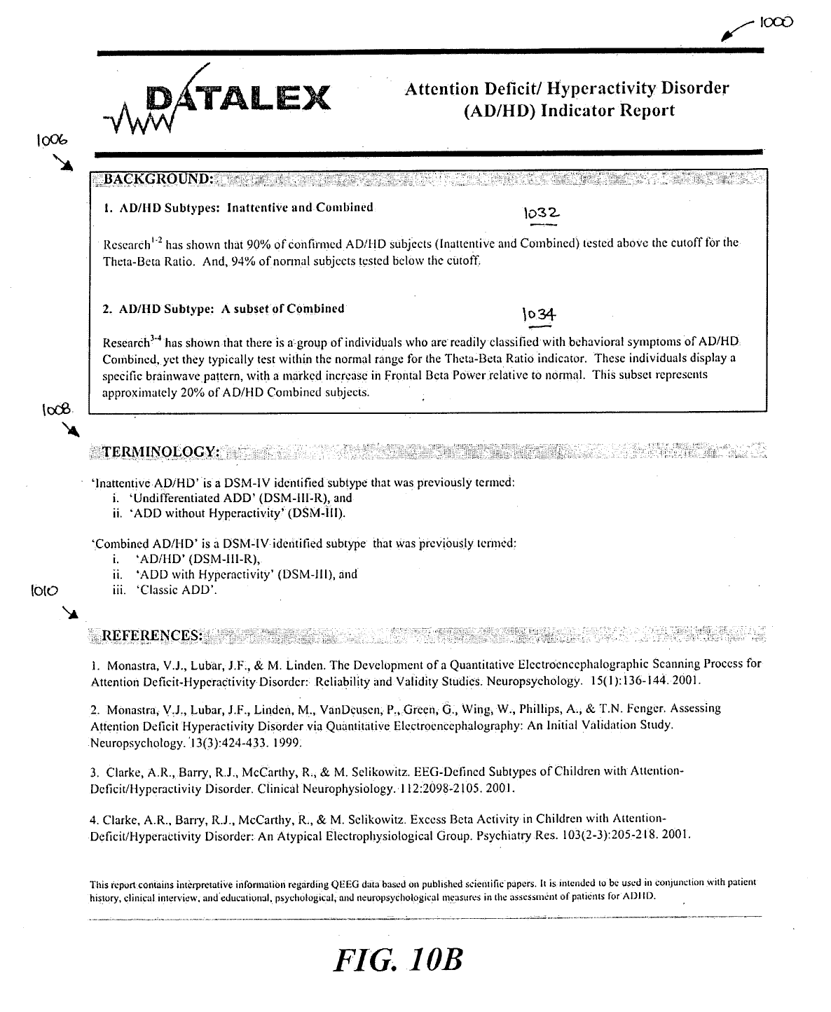

Report: A collection of output data that is compiled for analysis by one or more persons such as a health care provider or patient. An exemplary report generated in accordance with various embodiments of the invention is illustrated in FIGS. 10A and 10B.

Data Interpretation Tool: A presentation of one or more indicators that provides an analytical interpretation, or graphical view of one or more conditions for a particular patient. A data interpretation tool can include, but is not limited to, a graph or a chart.

Analytical Tool: An application of analysis to data associated with a patient from which an indicator can be derived, or by which an indicator can be fine tuned. An analytical tool can include, but is not limited to, statistical analyses, neural networks, learning machines, judgment schemes, evaluation and optimization schemes, and the like.

Reference will now be made in detail to exemplary embodiments of the invention, examples of which are illustrated in the accompanying drawings. Wherever possible, the same reference numbers will be used throughout the drawings to refer to the same or like parts.

An embodiment of the invention is a network-based process that provides tools for the interpretation of biological data. One of the goals of the network-based process is to facilitate the decision-making process that health care providers undergo when answering questions regarding a patient's health. One of the results of the process is a set of reports, each of which focuses on a specific condition, requires certain data, and provides data interpretation tools relevant to answering one or more questions about the particular condition.

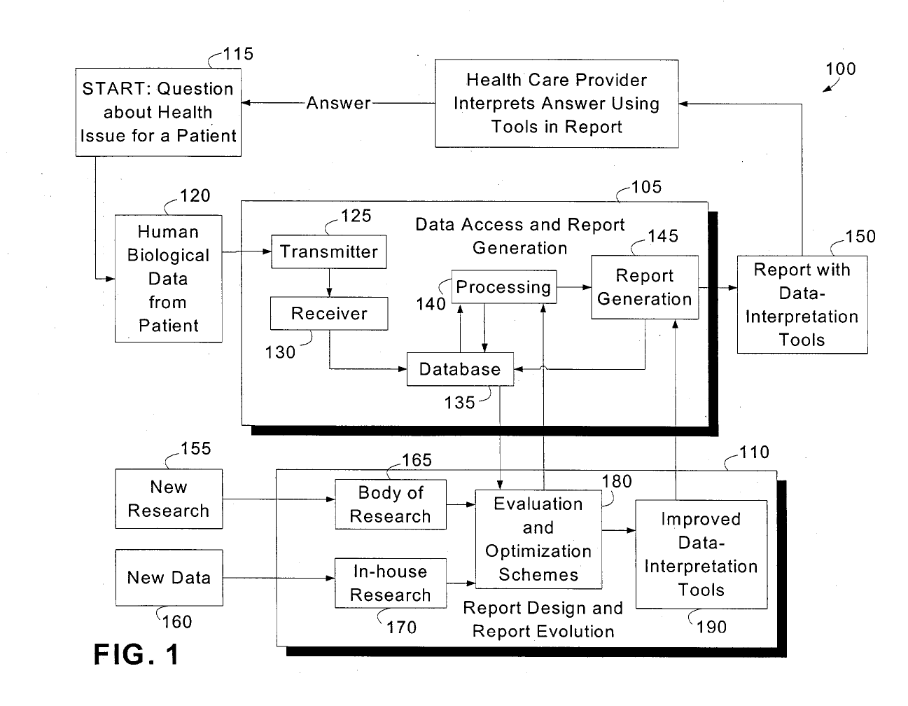

This particular network-based process in accordance with various embodiments of the invention can be described with the following stages: (1) report design and report evolution process, and (2) data access and report generation process. An example of this particular network-based process is shown in FIG. 1.

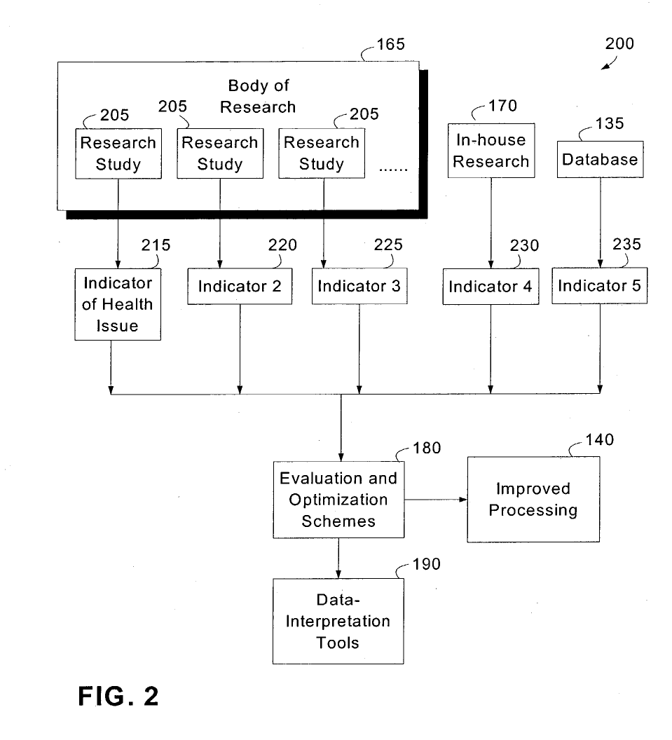

In the report design and report evolution process, the process includes a scheme for development and improvement of data interpretation tools. The data interpretation tools in a report include, but are not limited to, research-based concepts that accompany the processed biological data within graphs, text, and hyperlinked information. In the design of a report, an evaluation scheme is followed to determine which combination of research-based concepts may best facilitate the interpretation of the biological data in order to answer certain questions about the condition, as shown in FIGS. 1 and 2. Specific data interpretation tools are grouped together within a report when appropriate, such that the tools together provide more revealing information about a condition than would be provided by use of each tool alone.

While the content of an individual report shall be fixed on answering a particular question about a condition for a particular patient, the depth and complexity of the answer can evolve with time. This report evolution may develop due to structured changes in the number, type, and grouping of the data interpretation tools within a report. These changes may be determined from an ongoing evaluation scheme applied to the public body of research, patents, or in-house research and databases. Various aspects of report evolution are shown in FIGS. 1 and 2.

In data access and report generation, the following features can be included: (a) a means of transmission of biological data that was measured with one or more devices, (b) a means of receiving the transmitted biological data, (c) a set of mathematical tools used in the processing of the biological data, (d) a report generation scheme that combines the processed biological data with research-based data interpretation tools, and (e) a means of storage of the original data, the processed data, and the generated report. An example of the data access and report generation is shown in FIG. 1.

When data from an individual patient is being passed to the process as multiple sets of data in a semi-continuous scheme, there is an option to use a bi-directional feedback loop. In a bi-directional feedback loop, previously interpreted data is used to determine modifications in the stream of future sets of data.

In summary, this network-based process in accordance with various embodiments of the invention may simplify the requirements for the user, who may need only know what type of answer is being sought for a particular condition, and/or what type of data is required. This network-based process also facilitates access and handling of the biological data, processes the biological data, and provides a means of data interpretation in a report format.

Report Process

This description of a preferred embodiment of the invention involves the production of a report that addresses a specific condition. This embodiment is for examination of a single set of data. This embodiment includes the following stages: (1) report design and report evolution, and (2) data access and report generation.

Report Design and Report Evolution

A report is designed using analytical tools including, but not limited to, statistical analyses, neural networks, learning machines, judgment guidelines, and the like. The design of the report may be done manually, designed using an automated process, or by a combination of the two. One embodiment of a scheme for the design of a report includes but is not limited to the following steps: A staff of professionals decides which condition should be addressed in the report. A review of relevant scientific research is performed, and the findings of each important research study are summarized. The research findings are analyzed using the analytical tools mentioned above, either manually, or in an automated fashion. The outcomes of the analyses provide a view of consistent patterns in the research findings, which in turn connects the characterization of a condition to a certain type of biological data and/or processing scheme of the biological data. From these patterns in the research findings, a set of variables is selected and/or derived, which indicates the state of health of the patient with regard to a specific medical condition. The validity of these indicator variables and their use for characterizing a condition are verified by analysis, which includes but is not limited to statistical testing, neural networks, learning machines and judgment criteria based on the public body of research and in-house research. The determinations of the report are derived from the information inherent within the set of indicator variables. A variety of tools such as graphical images and report text are used to convey these determinations. The data interpretation tools include research-based concepts in the text and graphics of the report, which facilitate the interpretation of the indicators. Hyperlinks to other relevant information can be included. The report design is incorporated into the report generation scheme.

Data Access and Report Generation

One embodiment of a scheme for data access and report generation of a report includes, but is not limited to, the following steps: The user accesses the order form on the website. The user enters the patient information. The user utilizes the web site to upload data files to the website and archive database. The data files are imported from the archive database to a designated local area network (LAN). The data input by the user is cleaned or processed. For example, artifacts are removed. Artifacts are removed, for example, based on pattern recognition of noise within the data set. For example, one method used to investigate whether a patient has attention deficit/hyperactivity disorder (AD/HD) is to examine the readout of an electroencephalogram performed on the patient. In addition to the data showing the patient's brain wave activity, the data contains noise that is attributable to the patient blinking an eye, wrinkling his or her forehead, and the like. The data cleaning methods discern the patient's brain activity from the noise. Once the noise is identified, it is digitally removed from the data set. Preferably data files are analyzed using software programs designed for this purpose. Calculations are performed which ultimately produce a set of indicator variables, such as those described above in the report design process. Comparisons are made between the indicators and a normative database. The results are copied into the LAN repository. The report is generated. The report is labeled with an order number. Patient and clinical information is imported from the archive database. Indicator variable results can be displayed graphically or described in text. Report header information is entered. The report file is converted to the appropriate format and stored in LAN repository. The report may undergo quality control. The report is uploaded. The user is notified of report completion and availability on our web site.

Remote Patient-Monitoring Process

This description of the preferred embodiment of this invention involves a remote patient-monitoring unit that comprises: (1) connections to one or more medical instruments that collect biological data, (2) storage of the data in memory, and (3) uploading of the data at a given time to a central server for reporting and interpretation. This embodiment processes multiple sets of data in a semi-continuous scheme. This embodiment can be described with the following stages: (1) report design and report evolution, and (2) data access and report generation.

Report Design and Report Evolution

A scheme for report design and report evolution for remote patient monitoring includes, but is not limited to, the following steps: Perform review of relevant scientific publications for the condition or conditions being monitored. Select indicator variables that are relevant and particular for the condition. Verify the validity of the indicators within the body of research. Design the report to convey the messages needed, using graphical or textual means. Design data parameter notification event conditions relevant and particular for the condition. Organize a report layout including hyperlinks if necessary. Incorporate the report design into the report generation scheme.

The reports are continuously updated and refined, and the reports evolve in time. A scheme for evolution of a report includes but is not limited to the following steps: Research articles are constantly monitored for new indicators and notification event conditionals. Unique indicators may be developed using databases which are constructed from processed patient data, and may be combined with data collected by research studies. New indicators are selected by evaluation schemes using the above-mentioned analytical tools. The report is updated with the new indicators. Because this embodiment involves multiple sets of data being passed into our process in a semi-continuous scheme, there exists the opportunity as well for time-based analyses and comparisons.

Data Access and Report Generation

A scheme for data access and report generation for remote patient-monitoring comprises medical devices that are capable of transmitting data are used. The devices may have the capability to transmit data or the devices may be capable of transmitting data to an intermediate device that transmits the data to a remote location. The data may be transmitted by any means or in any form, such as landlines, wireless, satellite, analog or digital, or means and forms known to those skilled in the art. Medical devices are connected to a remote unit, preferably using a RS-232 interface (EIA-232). The device has a first level of processing consisting of an 8-bit, 16 MHz processor that commands the RS-232. The first level of processing then transfers the data to the core processor, consisting of an 8-bit, 30 MHz processor. The core processor archives the data locally in an EEPROM memory chip. In the process the core processor also time stamps the data with time information from a clock chip.

The next phase is to transport the biological data via an analog phone line to the central server. The communication is normally handled by a built-in ITU (Internation Telecommunications Union) CCITT (Comité Consultatif International Téléphonique et Télégraphique) v.22 bis modem. However, those skilled in the art will appreciate the biological data may be transmitted to the central server using other communications channels such as a T-1 line, a cable, a Digital Subscriber Line (DSL) line, wireless communications link and the like. The initial call settings (when to call, what number to call, etc.) are stored in the EEPROM memory at the remote unit, and govern when communication with the server is initiated.

This embodiment involves multiple sets of data being passed into the process in a semi-continuous scheme, and a bi-directional feedback loop can be used, so that previously interpreted data is used to determine modifications in the stream of future sets of data. Once data is uploaded to the server, it resets the pointer within the EEPROM memory at the remote unit. This resetting of the pointer allows the medical values stored in the EEPROM memory to be overwritten with new data. The server receives the data and stores it in a remote unit text file. A remote unit info text file can store call settings and other unit specific information. A third file can be employed as a remote unit log file that logs all communications with time stamps.

Once a medical data value has been passed completely to the text file, it is then written to a file of XML, HTML, text, or other format where the data is prepared for display. A web application then takes the data from the file and generates a viewable World Wide Web document. The data can be displayed or with hyperlinks to relational databases, research articles or previous patient records.

References will now be made in detail to this invention which are illustrated in the accompanying drawings. Wherever possible, the same reference numbers will be used throughout the drawings to refer to the same elements.

FIG. 1 is a block diagram illustrating a report production process 100 to produce a report that addresses a specific condition of a particular patient. The process 100 comprises a data access and report generation process 105 and a report design and report evolution process 110. The indicator report production process 100 begins at 115 when a user, typically a health care provider, accesses a web site associated with the report production process 100. Typically, the report production process 100 is located at a site remote from the location of the particular patient and the user. The user may access the remote site through a distributed network, such as the Internet, using a personal computer, personal digital assistant (PDA), or any other device that can connect to the distributed network.

Once the user accesses the website, the user is prompted to enter information about the particular patient. The information typically consists of patient demographics or demographic data, such as the patient identification number, age, gender. The user may enter the patient information manually or upload the information automatically. Typically, the patient's information is stored remotely on a database. Next, at 120, biological data is collected from the patient. This may include data from invasive procedures, such as blood samples, and biopsies, as well as data from non-invasive procedures, such as blood pressure readings, temperature readings, weight measurements, electrocardiograms (ECGs), electroencephalograms (EEGs), and the like. Clearly, physical samples from invasive procedures cannot be transmitted over a distributed network. In these cases, the associated data and/or images are transmitted to the web site. The patient information and the patient biological data are uploaded to the web site. A transmitter 125 at the web site uploads the patient's information and biological data to a receiver 130 at a central server. The patient's information and biological data are then stored in an archive database 135. A processor 140 removes unwanted artifacts from the uploaded data by, for example, using pattern recognition techniques of professional staff or automated removal by mathematical evaluation of noise. The processor 140 performs calculations and analyses with the data, and stores the resultant processed data back in the archive database 135. The processor 140 forwards the patient information and biological data to a report generation 145, which consists of a microprocessor. The report generation 145 also receives a set of data interpretation tools 190 from the report design and report evolution process 110. The data interpretation tools 190 are tailored to address the patient's condition based on the patient information and biological data. This process is explained in greater detail below.

The report generation 145 calculates a set of indicator variables from the patient's information and biological data that characterize the patient's current medical condition. The report generation 145 then provides text and graphs which incorporate comparisons between the indicator variables and the data interpretation tools 190 received from the report design and report evolution process 110. The results are written to the database 135. The report generation 145 then creates a report 150 containing the graphs and text, which is assigned a report order number for accounting purposes. Additional information to catalog and track the report, such as a report header and the like are added to the report 150. The report 150 is then converted to the appropriate format, such as Hypertext Markup Language (HTML) or Extensible Markup Language (XML), text, or any other format suitable for viewing by the user and uploaded to the website. The report 150 also includes the data interpretation tools so that the healthcare provider can make a final diagnosis of the patient's symptoms. The report 150 is not intended to replace the healthcare provider by providing a final diagnosis. Rather, the report 150 is a tool, which provides the healthcare provider with a collection of results from a variety of data interpretation schemes that are supplied in an informative and readable format to aid in diagnosing the patient's medical condition.

As described above, the report production process 100 includes a report design and report evolution process 110 that supplies a set of data interpretation tools 190 to the report generation 145. The report design and report evolution for a particular condition begins when a qualified professional or staff of professionals examines the results of new research 155 that are available within the public body of research 165, and the staff examines new data 160 from in-house coordinated research 170. In addition, the staff examines the data stored in the in-house database 135. The results from the in-house research 170 and the public body of research 165 are input to evaluation and optimization schemes 180 along with demographic information and biological data from the in-house database 135. In the evaluation and optimization schemes 180, analytical tools including but not limited to statistical analyses, neural networks, learning machines, and judgment schemes are applied to the data to produce improved data interpretation tools used to analyze the patient's data and to generate the report 150.

The evaluation and optimization schemes 180 are incorporated into two discrete schemes: a report design scheme and a report evolution scheme. In the report design scheme, a staff of professionals reviews and performs a meta-analysis on the current body of research and monitors current healthcare issues to decide which conditions are to be addressed and cataloged in the report design and report evolution process 110. Typically, the staff selects and examines scientific articles from relevant scientific journals and publications and prepares a summary of each relevant article. The staff also discerns data patterns within the research of a specific condition, characterizes the condition by these patterns, and identifies indicator variables that summarize or relates to these patterns.

In addition to reviewing, organizing, and analyzing the literature, the layout and format of the report 150 for each condition are determined to convey the information to the healthcare provider in the most efficient manner. This includes, but is not limited to, deciding the content of the report 150, determining what messages regarding the condition will appear in the report 150, designing graphical images to effectively convey the data, determining what, if any, hyperlinks to appropriate information should be included in the report 150, providing patent search results in the relevant areas, and documenting each reference used to generate the report 150. Although the preferred. embodiment uses individual people to perform the tasks associated with the design of the report 150, those skilled in the art will appreciate that other methods, such as an automated process using artificial intelligence, may also be implemented to make the decision as to the content and format of the report 150 without altering the scope of this invention.

In the report evolution scheme, the reports and indicators used for characterizing conditions are kept up to date with current scientific knowledge. To this end, the staff of professionals continues to examine relevant research articles to uncover new indicator variables for a particular condition, develop new indicators based on the evaluation of the data, and revise report formats based on the newly developed indicators that are used to create the improved data interpretation tools 190.

Another feature of the invention is remote patient monitoring and automatic data collection. Typically, the health care provider will supply a medical monitoring device, such as a blood pressure cuff or electrocardiogram monitor to the patient to monitor a particular function. The medical monitoring devices contain a microprocessor device connected to a data communications port such as an RS-232 interface. The microprocessor device, which is a standard microprocessor that is well known in the art, controls the operation of the communications port. Alternatively, the medical device may be connected to the microprocessor device via a wireless communications port, such as a short-range radio frequency (RF) communications port or an infrared (IR) communications port. The microprocessor device then transmits the patient's biological data obtained from the medical device to a core microprocessor device located at the patient's location over a distributed network. Typically, the core processor device is a centralized server located at the patient's location. The core microprocessor device stores the biological data locally in standard EEPROM memory and also time and date stamps the biological data. The biological data is then transmitted over a distributed network, such as the Internet to the central processing unit 140. Typically the core microprocessor device is connected to the distributed network using standard telephone lines. Alternatively, the core microprocessor unit may be connected to the distributed network via a T-1 line, a cable modem, DSL line, or any other appropriate communications medium.

The report production process 100 may also include a bi-directional feedback loop between the patient and the central processing unit 140. This allows previously received data from the patient to be used to determine whether any modification should be made in the stream of data being transmitted from the patient to the central processing unit 140. The process is programmed to perform the bi-directional function such that the central processing unit 140 can change the call settings of the remote unit either during an existing communication, or it can establish its own connection to change the remote units settings.

FIG. 2 is a block diagram illustrating a process 200 to improve and/or generate the data interpretation tools 190 and to optimize the data processing 140. A staff of professionals examines individual research studies 205 concerning individual conditions that have been compiled in the body of research 165. Upon review and meta-analysis of the research studies 205, the staff extracts a set of indicators 215, 220, and 225 that characterize a particular condition described by a particular research study 205. In addition to the research studies 205 in the body of research 165, the staff analyzes the raw data collected by in-house coordinated research studies 170 and analyzes the data from in-house databases 135. The staff then derives indicators 230 and 235 from the in-house research 170 and from the in-house database 135, respectively. Next, the individual indicators are input into the evaluation and optimization schemes 180, where the indicators are subjected to analyses which select specific indicators, group the selected indicators in meaningful combinations, and connect the indicators with research-based concepts that comprise the data interpretation tools 190.

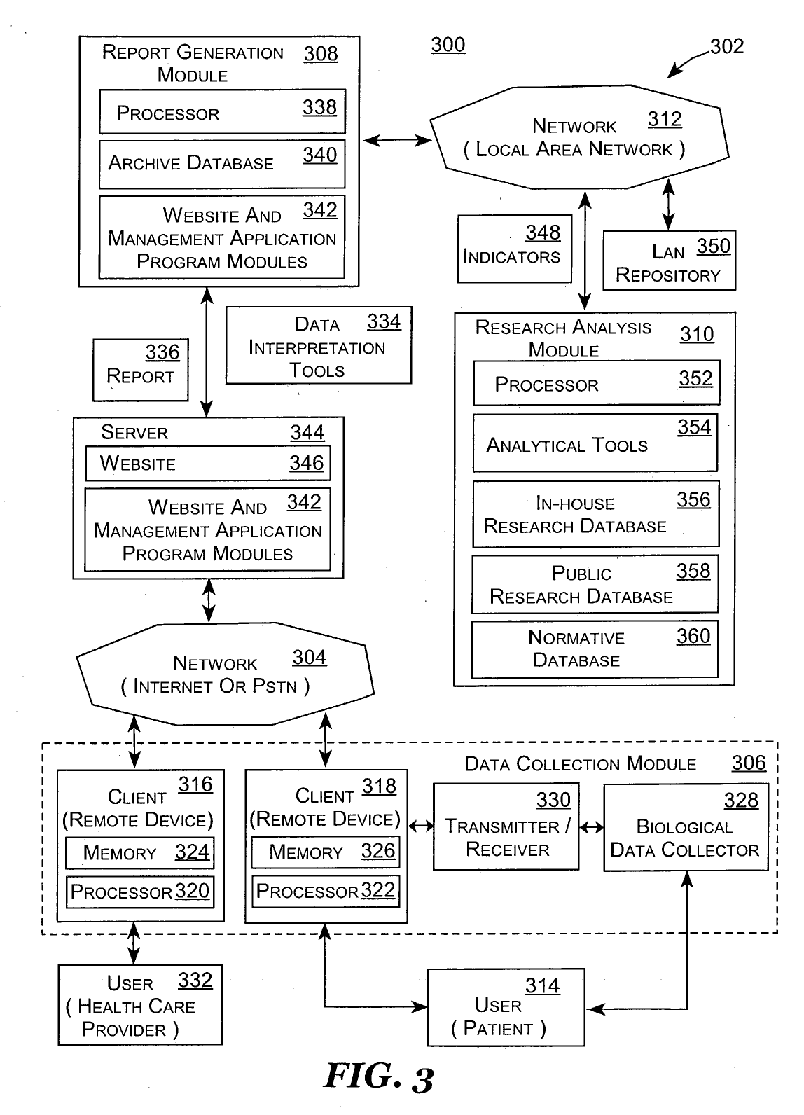

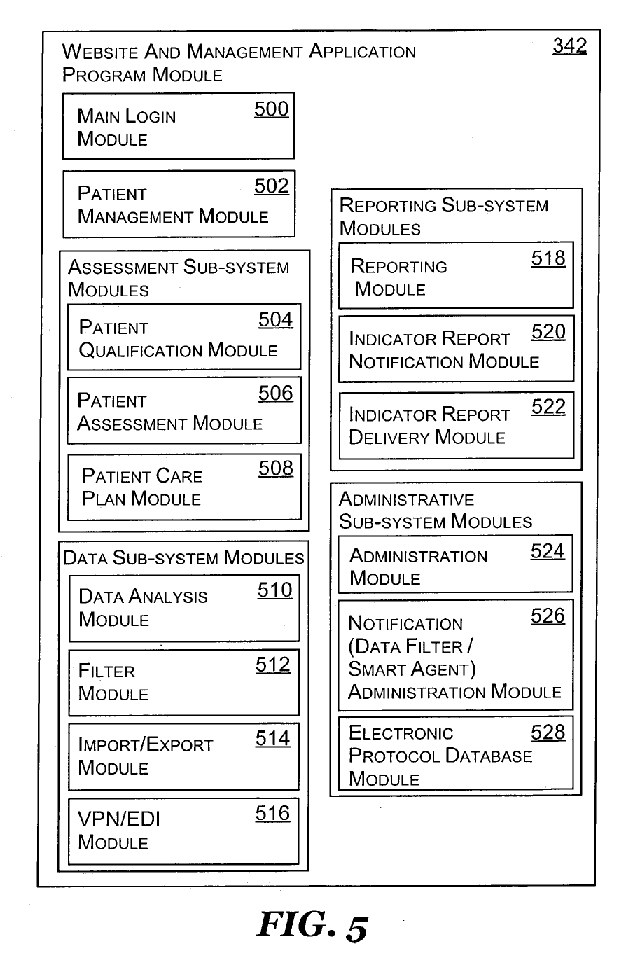

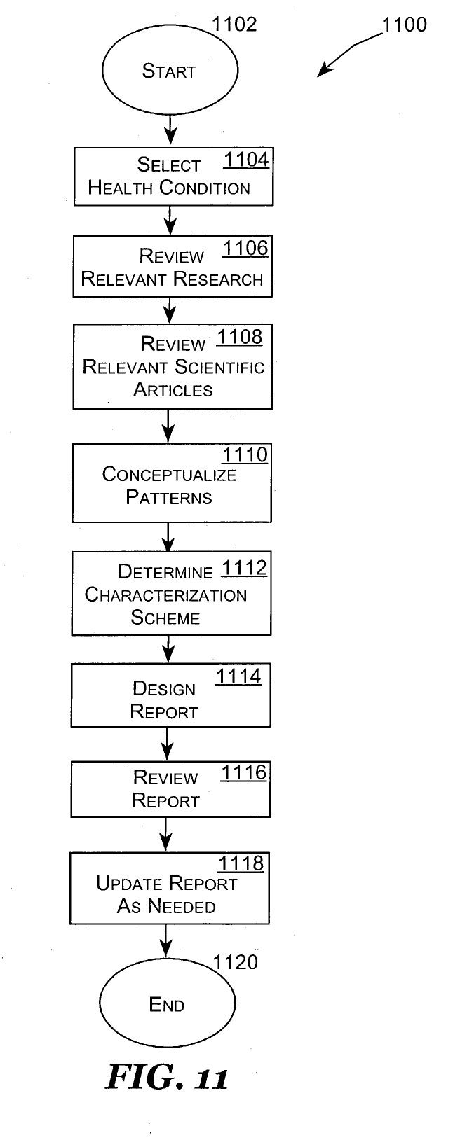

FIG. 3 is a preferred environment 300 for a system 302 in accordance with various embodiments of the invention. Using a system 302 illustrated in FIG. 3, the processes of FIGS. 1 and 2 can be implemented. Furthermore, the methods illustrated in FIGS. 5-9, and 11 can also be implemented using the system of FIG. 3. An exemplary system is sold by Lexicor Health Systems, Inc. under the names, “DataLex™ Health Monitoring System” and “DataLex™ Home Care System.”

Typically, the preferred environment 300 includes a network 304 in communication with the system 302. In turn, the system 302 includes one or more system modules 306, 308, 310 that operate in accordance with the invention. Each of the system modules 306, 308, 310 can communicate with each other through the network 304 or via an associated network 312 such as a local area network (LAN). For example, the system modules can be a data collection module 306, a report generation module 308, and a research analysis module 310. The data collection module 306 can commnunicate with the report generation module 308 via the Internet, and the research analysis module 310 can communicate with the report generation module 308 via a local area network. Other system modules in various configurations operating in accordance with the invention may exist.

Each of the system modules 306, 308, 310 can be hosted by one or more processor-based platforms such as those implemented by Windows 98, Windows NT/2000, LINUX-based and/or UNIX-based operating platforms. Furthermore, each of the system modules 306, 308, 310 can utilize one or more conventional programming languages such as DB/C, C, C++, UNIX Shell, and Structured Query Language (SQL) to accomplish various methods, routines, subroutines, and computer-executable instructions in accordance with the invention, including system functionality, data processing, and communications between functional components.

Each of the system modules 306, 308, 310 and their respective functions are described in turn below.

The data collection module 306 is adapted to collect biological data from a user such as a patient 314. The data collection module 306 includes one or more clients 316, 318 and/or remote devices in communication with the network 304 such as the Internet. Typically, each client 316, 318 is a processor-based platform such as a personal computer, personal digital assistant (PDA), tablet, or other stationary or mobile computing-type device adapted to communicate with the network 304. Each client 316, 318 can include a respective processor 320, 322, memory 324, 326 or data storage device, biological data collector 328, and transmitter/receiver 330. Other components can be utilized with the data collection module 306 in accordance with the invention.

The biological data collector 328 communicates with at least one client 316, 318 via a transmitter/receiver 330. In the embodiment shown, a biological data collector 328 such as a medical device obtains or otherwise receives biological data in real-time from a user such as a patient 314. The transmitter/receiver 330 transmits the received biological data from the biological data collector 328 or medical device to the client 318. In turn, the client 318 may temporarily store the biological data in memory 326 or otherwise process the data with the processor 322, and further transmit the data via the network 304 to the report generation module 308. In other embodiments, a biological data collector 328 may locally store and process collected data, and communicate the data directly to the network 304.

For example, a biological data collector 328 can be a medical device such as a Lexicor Neurosearch-24 quantitative electroencephalographic (QEEG) data acquisition unit and Electrocap (collectively referred to as “NRS-24 device”) provided by Lexicor Health Systems, Inc. This type of medical and associated configuration can be connected to a user or patient's head, and when activated, the medical device provides digitized EEG data via a proprietary digital interface and associated software that permits data to be stored locally in a file format such as a Lexicor file format on a host platform. In alternative embodiments, data can be transmitted in realtime via other interfaces such as USB to the host platform such as a server. Stored EEG data can be uploaded to an associated server or client as needed. In other instances, collected or stored data can be burned onto or otherwise stored in a digital format such as a CD-ROM disk and then transmitted or transferred to an associated server or client.

Note that a Lexicor file format can be a Lexicor raw EEG data file format developed by Lexicor Health Systems, Inc. This particular file format has a data structure that is adapted to store 24 channels of digitized EEG data to facilitate offline data analysis. Although various EEG storage formats exist, the Lexicor file format can be adapted to handle these and other data storage formats. For example, the Lexicor file format has a global header with 64 integers to handle information such as sample rate, gain of the front end NRS-24 amplifiers, software revision, an total number of epochs. Further, the Lexicor file format can include one or more epochs or sections of raw data including a 256 byte text array to handle comment entries, as well as an array to handle raw digitized EEG data collected by a NRS-24 device during a particular acquisition period for a particular epoch, and a local header containing the epoch number and status of the particular epoch.

A biological data collector 328 can include, but is not limited to, blood pressure monitors, weight scales, glucose meters, oximeters, spirometers, coagulation meters, urinalysis devices, hemoglobin devices, thermometers, capnometers, electrocardiograms (EKGs), electroencephalagrams (EEGs), other digital medical devices that can output data via a RS-232 port or similar type connection, and other devices or methods that provide data associated with a biological or physiological function. Biological data collected or otherwise received from a user or patient can include, but is not limited to, blood pressure, weight, blood component measurements, bodily fluid component measurements, temperature, heart measurements, brainwave measurements, and other measurements associated with a biological or physiological function.

The transmitter/receiver 330 typically facilitates the transfer of data between the biological data collector 328 and client 318. The transmitter/receiver 330 can be a stand alone or built-in device. The transmitter/receiver 330 can include, but is not limited to, a RS-232 compatible device, a wireless communication device, a wired communications device, or any other device or method adapted to communicate biological data.

A user such as a healthcare provider 332 can share or separately utilize a client 316, 318 to interact or communicate with the network 304 depending upon the proximity of the client 316, 318 to the patient 314. The healthcare provider 332 and/or patient 314 may receive specific instructions from the report generation module 308 via the same or a respective client 316, 318. For example, in response to a particular condition, the report generation module 308 may request that from the health care provider 332 that specific biological data be collected from the patient 314. Appropriate instructions may be communicated to the health care provider 332 via the network 304 to the client 316. The health care provider 332 can then instruct the patient 314 or otherwise assist the patient 314 in connecting the biological data collector 328 or medical device to the patient 314. When activated, the biological data collector 328 or medical device can transmit biological data associated with the patient 314 via the network 304 or Internet to the report generation module 308. As needed, a healthcare provider 332, and/or patient 314, or other user can input demographic data or otherwise provide demographic data via a respective client 316, 318.

The report generation module 308 is adapted to receive, store, and process the biological data from the patient 314 for subsequent retrieval and analysis. The report generation module 308 is also adapted to generate one or more data interpretation tools 334 based upon collected or otherwise received biological data from the patient 314. Further, the report generation module 308 is adapted to generate a report 336 including one or more data interpretation tools to assist a user such as a health care provider 332 in managing and analyzing biological data. A report is described in greater detail with respect to FIGS. 10A and 10B. In addition, the report generation module 308 is adapted to execute a website and management application program module 342 as described in FIG. 5.

Typically, the report generation module 308 is a processor-based platform such as a server, mainframe computer, personal computer, personal digital assistant (PDA). The report generation module 308 includes a processor 338, an archive database 340, and a website and management application program module 342. A separate server 344 to host an Internet website 346 can be connected between the report generation module 308 and the network 304 or Internet; or otherwise be in communication with the report generation module 308 and data collection module 306 via the network 304 or Internet. Generally, the separate server 344 is a processor-based platform such as a server or computer that can execute a website and management application program module 342. In any instance, the report generation module 308 communicates with the data collection module 306 via the network 304 or Internet. Other components can be utilized with the report generation module 308 in accordance with the invention.

The processor 338 handles biological data and demographic data received from the data collection module 306. The processor 338 can store the biological data and demographic data in the archive database 340 for subsequent retrieval, and/or process the biological data using other data received from the research analysis module 310. Typically, the processor 338 analyzes biological data and demographic data from the data collection module 306 and removes unwanted artifacts from the data. Relevant biological data and demographic data is then stored in the archive database 340 until called upon. Using indicators 348 received from the research analysis module 310, the processor 338 processes the biological data and demographic data to generate the indicators 348 in association with one or more data interpretation tools 334. The processor 338 then generates a report 336 including one or more indicators and associated data interpretation tools 334 for transmission via the network 304 to a user such as the health care provider 332 and/or patient 314.

Data interpretation tools 334 add relevant information and context to biological and demographic data in a report 336, such that the data can be more readily interpreted by a user such as a health care provider 332 to determine the state of a particular condition with a particular patient 314. Data interpretation tools 334 typically include patterns of biological and demographic data for normal subjects and subjects with the condition. The patterns of biological and demographic data are presented in a report 336 which can include graphs and text. These patterns are determined from a meta-analysis of the body of scientific literature, and analysis of relevant databases for normal subjects as well as those with a particular condition and those with related conditions. One example of a set of data interpretation tools 334 is illustrated in Lexicor's AD/HD Indicator Report, shown and described with respect to FIGS. 10A and 10B.

The archive database 340 can be a database, memory, or similar type of data storage device. The archive database 340 is adapted to store biological data such as medical images, medical data and measurements, and similar types of information, as well as demographic data as previously described. Generally, the archive database 340 is utilized by the report generation module 308 to store biological data and demographic data until called upon.

The website and management application program module 342 is typically a set of computer-executable instructions adapted to provide a website 346 with at least one functional module to handle data communication between the website 346 and at least one user such as a health care provider 332 and/or patient 314. The website and management application program module 342 can be hosted by the report generation module 308, separate server, and/or a storage device in communication with the network 304. A website and management application program module 342 can include, but is not limited to, a main login module, a patient management module, a patient qualification module, a patient assessment module, a patient care plan module, a data analysis module, a filter module, an import/export module, a virtual private network electronic data interchange (VPI EDI) module, a reporting module, an indicator report notification module, an indicator report delivery module, an administrative module, a notification (data filter/smart agent) administration module, a database module, and other similar component or functional modules. An exemplary website and management application program module 342 is illustrated and described with respect to FIG. 5. Other component modules associated with the website and management application program module 342 can operate in accordance with the invention.

The separate server 344 is adapted to host the website 346 viewable via the Internet with a browser application program. Alternatively, the separate server 344 may host a website and management application program module 342 as well. A website 346 provides communication access for a health care provider 332 and/or patient 314 to the report generation module 308. For example, a report 336 generated by the report generation module 308 may be posted to the website 346 for selective access and viewing via the network 304 or Internet by a user such as a health care provider 332 and/or patient 314 operating the same or a respective client 316, 318 via the network 304. In other instances, a report 336 may be transmitted by the report generation module 308 to a user such as a health care provider 332 and/or patient 314 via an electronic mail message communication, a telecommunications device, messaging system or device, or similar type communication device or method. An exemplary report generated in accordance with various embodiments of the invention is illustrated and described in detail below in FIGS. 10A and 10B.

The associated network 312 is typically a local area network (LAN) that provides communications between the report generation module 308 and the research analysis module 310. A LAN repository 350 may be connected or otherwise accessible to the associated network 312 for additional storage of biological data, indicators, or other data collected, generated, or otherwise received by the system 302.

The research analysis module 310 is adapted to obtain and collect relevant research materials and data. Furthermore, the research analysis module 310 is adapted to process relevant research materials and data, and to determine one or more indicators 348 for a particular condition. Moreover, the research analysis module 310 is adapted to provide indicators 348 to the report generation module 308 in response to a particular patient's condition or collected biological and demographic data. Typically, the research analysis module 310 is a processor-based platform such as a server, mainframe computer, personal computer, or personal digital assistant (PDA). The research analysis module 310 includes a processor 352, analytical tools 354, an in-house research database 356, a public research database 358, and a normative database 360. Other components can be utilized with the research analysis module 310 in accordance with the invention.

The processor 352 handles research and data collected or otherwise received by the research analysis module 310. The processor 352 either indexes and/or stores the research or data in an associated database for subsequent retrieval, or processes the research and data using one or more analytical tools 354. One or more indicators 348 can be provided or otherwise derived by or from the analytical tools 354, and the processor 352 transmits any indicators 348 to the report generation module 308 as needed.

At least one analytical tool 354 is utilized by the research analysis module 310. Typically, an analytical tool 354 is an algorithm that utilizes research and data to determine one or more indicators 348 for a particular condition.

The in-house research database 356 is a collection of research and articles provided by a particular or third-party vendor. Typically, an entity operating the system 302 can provide its own research and articles for a range of conditions. For example, information available from an in-house research database includes, but is not limited to, electronic databases, scientific and research journals, on-line sources, libraries, standard textbooks and reference books, and on-line and printed statements of committees and boards, and the like.

The public research database 358 is a collection of research and articles provided by one or more third-parties. Typically, research and articles are available for free or upon payment of a fee from a variety of on-line or otherwise accessible sources. For example, information available from a public research database 356 includes, but is not limited to, electronic databases, scientific and research journals, on-line sources, libraries, standard textbooks and reference books, on-line and printed statements of committees and boards, and the like.

The normative database 360 is a collection of electronic databases, scientific and research journals, on-line sources, libraries, standard textbooks and reference books, on-line and printed statements of committees and boards, and the like.

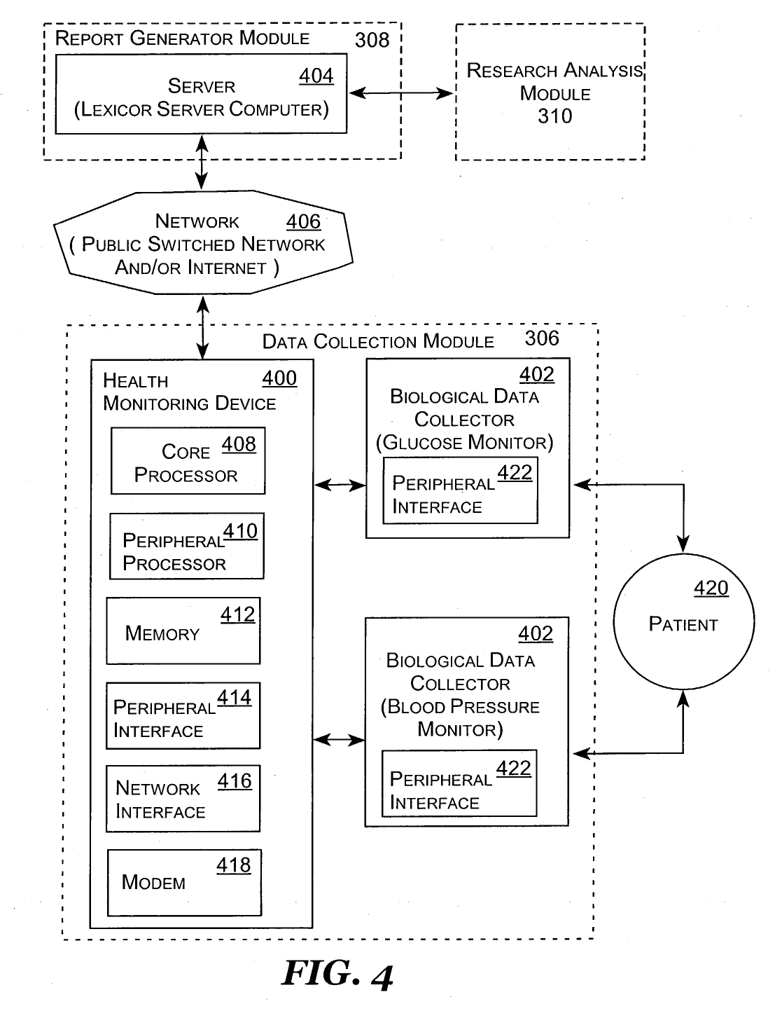

FIG. 4 is a functional block diagram of another exemplary remote device that operates with the system 300 of FIG. 3 in accordance with the invention. The remote device or health monitoring device 400 operates with in conjunction with a data collection module 306, report generation module 308, and research analysis module 310 such as those described in FIG. 3. The remote device or health monitoring device 400 shown in FIG. 4 is adapted to acquire, store, and transmit biological and demographic data acquired or otherwise received from a user such as a patient. Typically, the health monitoring device 400 acquires, stores, and re-transmits serially received physiological information acquired from various physiological monitors associated with a patient. In at least one embodiment of the system 300 in FIG. 3, the health monitoring device 400 operates as a remote device for home care-type services. An example of a remote device or health monitoring device is distributed and sold by Lexicor Health Systems, Inc. under the name “HealthWatch™ 1.5A” or “DataLex™ Health Track.”

The health monitoring device 400 operates in conjunction with at least one biological data collection device 402, a server 404, and a network 406. The health monitoring device 400 communicates directly with each respective biological data collection device 402, and further communicates with the server 404 via the network 406.

The health monitoring device 400 includes a core processor 408, at least one peripheral processor 410, a memory 412, a peripheral interface 414, a network interface 416, and a modem 418. Other configurations can include fewer or other components in accordance with the invention. For example, the health monitoring device 400 can include, but is not limited to, a super cap that supplies current to keep the date/time chip powered during an interruption or power shutdown; LEDs to indicate the functional state of the device; a push button switch; and a power supply connector. As one skilled in the art will recognize, the health monitoring device 400 can also incorporate a number of additional passive components such as resistors, capacitors, crystals, current limiters, sockets, and connectors in accordance with the invention.

The core processor 408 receives data from each of the peripheral processors 410. The core processor 408 can time stamp the data using information from an associated date/time chip. Time-stamped received data can then be stored by the core processor 408 in the memory 412 such as a non-volatile flash memory. A suitable core processor is sold by Paralax, Inc. under the name “Parallax BS2-SX.”

Each of the peripheral processors 410 receive data from a respective biological data collector 402. Furthermore, each peripheral processor 410 is adapted to communicate via at least one peripheral interface such as a pair of RS-232 bi-directional serial interfaces. Typically, each peripheral processor 410 communicates with only a particular subset of biological data collectors 402 or medical monitors. In some instances, a peripheral processor 410 may request data from a particular biological data collector 402 or medical monitor; and in other instances, the biological data collector 402 or medical monitor sends data via its respective peripheral interface to the health monitoring device 400 whenever biological data is collected or otherwise received from a patient.

In at least one preferred embodiment, there are three peripheral processors operating in conjunction with at least one associated date/time chip interfaced to a core processor. Each of the peripheral processors operates in conjunction with a watchdog-type timer chip interfaced to a respective peripheral processor. Suitable peripheral processors and associated date/time chips are sold respectively by Microproducts, LLC under the name “UBICOM SX28” and by Maxim Integrated Products under the model number “DS1202”. Suitable timer chips are sold by Maxim Integrated Products under the name “MAX690”. Fewer or greater numbers of peripheral processors, date/time chips, and watchdog-type timer chips can exist depending upon the number of biological data collectors and the processing capacity of the core processor 408. Furthermore, each peripheral processor 410 may communicate with other types of peripheral interfaces in accordance with the invention.

The memory 412 stores data received by either the core processor 408 and/or each of the peripheral processors 410. As described above, time-stamped data from the core processor 408 can be stored in the memory 412. A predetermined number of pre-programmed “CALL-TIMES” may also be stored in the memory 412. These “CALL-TIMES” may be called upon by the core processor 408 whenever an associated date/time chip determines whether a matching time is stored in the memory 412. In these instances, the health monitoring device 400 initiates a call to the server 402 over the network 406 via the modem 418. In other instances, a call may be manually initiated by a user depressing a call button associated with the health monitoring device 400.

Furthermore, the memory 412 can be adapted with a pointer that allows biological data that is uploaded to the server 402 to be overwritten by future biological data acquired or otherwise received from one or more medical monitoring devices 400 via the processor 408. A suitable memory 412 is a non-volatile flash memory chip or similar type of storage or memory device.

The peripheral interface 414 permits the biological data collector 402 or medical monitor to communicate directly with the biological data collector 402. A respective peripheral interface 414 can be used to input data from one or more biological data collectors 402 such as medical monitors, using a respective protocol unique to each biological data collector 402 or medical monitor and further defined by a respective manufacturer of each collector 402 and/or medical monitor. In this embodiment, the peripheral interface 414 is a set of four (4) RS-232 ports and connectors with associated interface chips. One skilled in the art will recognize that other types of communication ports, wireless-type or hard wired-type communications, or other communication equipment can be used in accordance with the invention.

The network interface 416 provides communications between the health monitoring device 400 and the server 402. The network interface can include, but is not limited to, a card, chip, or device that facilitates network communications between the health monitoring device 400 and the server 402.

The modem 418 permits the remote device or health monitoring device 400 to communicate via the network 406 with the server 402. In this embodiment, the modem 418 includes a 2400 baud modem and respective RS-11 phone jacks. One skilled in the art will recognize that other types of modems, communication devices, wireless-type or hard wired-type communications devices can be used in accordance with the invention.

A biological data collector 402 is typically a medical device or medical monitor that is adapted to receive or otherwise collect biological data from a patient 420. More than one biological data collector 402 can be simultaneously connected to the health monitoring device 400. For example, medical monitors can include, but are not limited to, glucose monitoring devices, weight measuring devices or scales, SaO2 measuring devices, blood pressure monitors, and heart rate monitors. Other medical devices and/or medical monitors can operate with the health monitoring device 400 in accordance with the invention.

Each biological data collector 402 includes a respective peripheral interface 422 in communication with a respective peripheral interface 414 of the health monitoring device 400. For example, the peripheral interface 422 can be a RS-232 port and connector in communication with a corresponding peripheral interface 414 such as a RS-232 port and connector of the health monitoring device 400. One skilled in the art will recognize that other types of communication ports, wireless-type or hard wired-type communications, or other communication equipment can be used in accordance with the invention.

Additional inputs such as demographic data may be communicated via the biological data collector 402, or associated client, or user interface. Ultimately, biological and demographic data may be handled and processed in a similar manner by the health monitoring device 400.

The server 404 can be associated with or in communication with the report generator module 308. In either instance, the server 404 is adapted to communicate with the remote device or health monitoring device 400 via the network 406. When a call is received from the health monitoring device 400, the server 404 is adapted to verify and authenticate the user operating the health monitoring device 400. Authentication can be accomplished with a unique serial number or other similar type of authentication or verification device, technique, or method. Once the user's identity is authenticated, the server 404 is further adapted to receive collected and/or processed biological and demographic data from the health monitoring device 400. An example of a suitable server is provided by Lexicor Health Systems, Inc. and referred to as a “Lexicor server computer.”

The server 404 typically includes a software-driven routine or set of computer-executable instructions that collect the received biological data from the health monitoring device 400, and generates an associated text file to be stored in a memory storage device. The software-driven routine may also include a handshaking protocol between the server 404 and the health monitoring device 400, i.e. between modems, once received data has been collected from the health monitoring device 400. Note that the server 404 is similar to the server described as 344 in FIG. 3. Typically, data is “pulled” from the health monitoring device 400 rather than “pushed” to the server 404. Those skilled in the art will recognize that data can also be pushed to the server 404 in accordance with the invention.

The server 404 is further adapted to store the biological and demographic data in an associated memory storage device. A suitable memory storage device is shown as an archive database 340 in FIG. 3. In some instances, the server 404 can transfer received biological and demographic data to another server, memory storage device or other similar type device in communication with the network 406. In any instance, a stored file with the received biological and demographic data may then be called upon by a transaction such as a DTS (Data Transformation Service) transaction that transforms and stores the data in an associated database such as a SQL database. After biological and demographic data has been stored by the server 404, the server 404 can send a command to the health monitoring device 400 that resets the pointer in memory 412 so that old data can be overwritten. Furthermore, the server 404 can reset predetermined “CALL-TIMES” and/or the associated date/time chip to permit field reprogramming of the memory 412 associated with the health monitoring device 400.

The network 406 is typically a public switched telephone network (PSTN) or similar type of network. In some instances, the network is the Internet, a communications network, or other type of network that permits data to be communicated between the health monitoring device 400 and the server 404 in accordance with the invention. Those skilled in the art will recognize various communications equipment, including wired and wireless communications devices, methods, and techniques that will facilitate communications between the health monitoring device 400 and the server 404.

FIG. 5 is a functional block diagram of an exemplary website and management application program module illustrated in FIG. 3. The website and management application module 342 provides various components or functional modules to handle data communication between the website 346 and at least one user such as a health care provider 332 and/or patient 314. As shown in FIG. 3, an exemplary website and management application program module 342 communicates with a user 314, 332 via a network 304 such as the Internet or public switched telephone network. The functional modules 500-528 of FIG. 5 illustrate exemplary features of the website and management application module 342 and those skilled in the art will recognize that other components or functional modules may be associated with the website and management application program module 342 in accordance with the invention. Typically, each of the component or functional modules 500-528 is a software program, routine, sub-routine, or set of computer-executable instructions adapted to provide functionality in accordance with the invention.

A main login module 500 is adapted to setup a user profile for a particular user. A user profile identifies a user such as a patient 314 or health care provider 332 with identifying or otherwise unique information associated with the user. The user can be stored in an associated memory storage device for subsequent retrieval and processing. Furthermore, the main login module 500 is adapted to control user access authorizations with the website 346. Since the website 346 may be accessible via a network 304 such as the Internet or public switched telephone network, secure access to the system 302 may be desired. In addition, the main login module 500 is adapted to permit a pre-specified level of user access to an associated database such as an archive database 340. As various users may desire access to one or more databases associated with the system 302, different levels of user access to one or more databases associated with the system 302 can be predetermined and administered by the main login module 500. For example, a patient 314 accessing the system 302 may not be allowed to access other patient records or data stored in a patient database.

A patient management module 502 is adapted to provide functionality for a user such as a health care provider 332 to review and manage patient data including activity data and patient assessment data. The patient management module 502 is further adapted to provide functional tools that include, but are not limited to, reviewing a patient list, viewing a patient medical device data and/or associated charts, adding and reviewing patient notes, manage health care provider data, access team data, view and manage patient, team, and health care provider data, initiate reports, and management.

A series of assessment sub-system modules 504-508 handle functionality associated with qualifying a patient 314 for using the system 302, assessing a patient's suitability for using the system 302, and preparing a patient plan of care. A patient qualification module 504 is adapted to assist a user such as a health care provider 332 in selecting appropriate patients for remote patient monitoring by the system 302. The patient qualification module 504 is adapted to determine a likelihood of a particular patient to be able to use and progress while utilizing aspects of the system 302. After qualifying a patient, the patient qualification module 504 is adapted to indicate appropriate medical devices and protocols for a particular patient's health issues and/or needs. Further, the patient qualification module 504 is adapted to provide an attending health care provider a reference or lookup chart with a list of one or more patients to facilitate individual patient analysis. For example, a health care provider 332 using the patient qualification module 504 can be prompted by the website 346 to enter patient data in response to question/answer (Q&A) format designed to elicit or obtain information about the patient. The website 346 transmits this information to an associated database 340, and the patient qualification module 504 guides a health care provider's decision making with appropriate answers or results, and provides options for a health care provider's objective or subjective analysis and decisioning.

Further, the patient qualification module 504 is adapted to assist a health care provider 322 in selecting a particular patient and to assign at least one appropriate biological data collector 328 or other associated medical devices for remote patient monitoring using the system 302. For example, the patient qualification module 504 provides a rules-based tool that allows a user, such as a health care provider 332, to engage in a systemic process that can be applied in a simple static scored mode, a manually tailored mode by weighting scored criteria, and/or an automatically weighted mode as user-entered data is collected and observations are applied by the tool. The user 332 enters answers to a set of predetermined questions relative to critical patient data such as primary diagnosis and other diagnoses), and then answers a number of questions related to patient data in categories of financial expenditure, resource utilization, severity index, and/or custom user organization-specific criteria. The output of the process provides the user 332 with a score that can be used to determine a patient's qualification status. The qualification status determines the likelihood of a patient 314 to be able to benefit from and progress on the system 302 relative to the goals of the user organization. Additionally, the results for a “qualified” patient would provide indication of which self-management or point-of-care medical device(s) are appropriate and with what suggested applicable protocols.

In at least one embodiment, the patient qualification module 504 provides a simple scoring system whereby a user 332 selects the appropriate data for each question. Each data entry carries an un-weighted score, and a determination is made based on the cumulative score for all questions. In this mode, the higher score represents a higher likelihood that a subject patient will or can benefit from the addition of remote patient monitoring into the disease management protocol. The biological data collector 328 or other associated medical devices that may be or are appropriate with suggested applicable protocols are static in this mode and based on available research data, standardized guidelines and standard of care guidelines.

Another level of use is to add a weighting criteria based on subjective goal setting within the organizational application of the system 302. The activities and application of the patient qualification module 504 are similar to that described above. The use of weighting criteria does not change the process but is intended to allow an organization to exert increased import to certain criteria. A user organization can add “weight” criteria to the questions within the patient qualification module 504 in order to provide additional emphasis on a particular subject area within the module 504. The use of weighting criteria in this mode is strictly subjective and specific to the using organization. It is intended to allow the using organization to stress one particular qualification area over others based on the overall goals of the organization. The software applies the weight assignments to the established numerical scores for each data element assigned to the individual questions within the patient qualification module 504. As in the un-weighted mode, the higher score represents a higher likelihood that a subject patient will or can benefit from the addition of remote patient monitoring into the disease management protocol. The biological data collector 328 or other associated medical devices that may be or are appropriate with suggested applicable protocols are static in this mode and based on available research data, standardized guidelines and standard of care guidelines.

In an objective mode of the patient qualification module 504, the weighting criteria can be established from the self-optimization and analysis process within the data contained in an associated database or memory storage device. The activities and application of the patient qualification module 504 are similar to the earlier description. A difference is that the weighting criteria are no longer subjective and specific to the using organization but objectively derived from observations of past experience. As data is developed, the criteria within the patient qualification module 504 are weighted based on the analysis of observations established and based on critical patient data elements including primary diagnosis and other diagnosis(ses), severity index, age, and others. The goal is as the data is collected, analysis can be applied such that both the process of qualification and selection of at least one biological data collector 328 or other associated medical devices are more effective. By observing the outcome results for similar patient profiles there can be applied improvements allowing a gradual increase in the effectiveness and efficiency of the overall system 302.

A patient assessment module 506 is adapted to allow a user such as a health care provider 332 to assess data associated with a biological data collector 328 collecting or otherwise receiving data from a patient 314. For example, the biological data collector 328 can be associated with the device referred to previously as “HealthWatch™1.5A.”. Further, the patient assessment module 506 is adapted to establish a baseline during an initial patient assessment session, where the baseline can be used to determine and continuously monitor the patient's progress while using the biological data collector 328. Moreover, the patient assessment module 506 is adapted to score a patient using standardized, predetermined criteria within an assessment tool obtained from a patient care plan module 508, further described below. The patient assessment module 506 is further adapted to benchmark in-process assessments versus the initial assessment to provide near or real time process adjustments. In addition, the patient assessment module 506 is adapted to provide discharge assessment where a health care provider can be provided with information to determine efficacy and effectiveness of a process and overall system, such that a discharge assessment can be based on Outcome Assessment Information Set (OASIS) criteria for reporting compatibility. For example, a health care provider 332 using the patient assessment module 506 can enter patient data to the website 346 in response to predetermined questions, and then receive an automatically generated assessment regarding the patient's data. In some instances, the patient assessment module 506 can be customized for OASIS and organizational policies as needed, such as including specific questions designed to address aspects of a particular organization's policies.

Furthermore, the patient assessment module 506 provides a software tool to allow a using health care provider 332 to assess monitored patient in subjective, yet structured process that is complementary when using the system 302 such as a DataLex™ Home Health system for remote patient monitoring. The patient assessment module 506 allows a health care provider 332 to supplement the objective data from collection directly from a patient 314 with periodic assessments that can then be used to determine progress within a disease management protocol. The process begins with an initial patient assessment that would establish a baseline for determining progress while on the system within a given disease management protocol or organizational care plan. Each patient assessment is scored based on standardized, preset criteria within the assessment tool derived from OASIS established by the Center for Medical Services (CMS) and obtained from a patient care plan module 508 provided by the system 302.

A protocol provided by the patient care plan module 508 could be used to establish the frequency of assessment. In-process assessments would be bench marked against the initial assessment to allow near-real-time process adjustment. The patient assessment module 506 allows a user such as health care provider 332 to compare assessments on a time line longitudinally by date in order to determine patient progress, compliance with the management protocol, and illuminate or discover areas where additional emphasis is required or where emphasis is no longer required.

Longer term, as patient data is collected and analyzed, bench marks can be obtained or established against both the individual patient progress and against an appropriate patient pool. As data is collected from a patient population over time achieving a level of statistical viability, the data can be analyzed and optimized such that demographically specific norms can be derived and established for a patient population within a specific disease category. Derivation and establishment of norms would be a direct result of the optimization algorithms as described and would be further validated using conventional evidence-based protocols.

The raw data can be collected across a diverse population based on one or more services provided to a client base, such as health care providers and patients. The accumulation of that data when combined with demographic and other assessment data provides a statistical basis for artifacting and optimization so that discrete ranges can be established for other patients using the system 302. The result of the optimization becomes diagnosis specific and stratified by demographic characteristics normative values. These values do not become absolutes but rather optimal range values that provide indicators as to the current health status and predictive information about expected or observed changes in biophysical measures as they are received. The basis of the artifacting and optimization process algorithm is the same as described for the QEEG data with minor application specific customization principally in the focus on diagnosis and an accumulated database.

In the instance when a range of quantitative variables are derived for a patient with a congestive heart failure, the variables are compared to a normative database. A single variable may be produced using a discriminant equation. The discriminant equation can be based upon published research and/or in-house research comparing selected and weighted biophysical measurement variables of normative and congestive heart failure databases. The discriminant variable is then compared against a benchmark demonstrated to indicate severity and changes in severity or status of the patient condition.

In any instance, depending upon the comparison results with existing research, benchmarks, or other data, one or more of the indicator variables can be modified or otherwise adjusted as needed. Specifically, this applies in cases when additional comorbid diagnoses exist complicating the patient condition. In this instance, factoring or weighting of the variables by a health care provider would provide the basis for predictive outcome results.

In the example above, meta-analysis for the selected variables included searches of relevant scientific literature and electronic databases or sources such as MEDLINE. Relevant terminology associated with relevant keywords such as “CHF” and “congestive heart failure” can be sought in titles, abstracts, and manuscript keywords of various literature, databases, and sources. Searches can also be limited in time, such as emphasizing studies published from 1995 to 2002.

Establishment of the norms would also include consideration of bench marks with and without additional diagnoses and comorbidities in order to retain relevance to a particular patient. In this manner, a health care provider can compare and contrast patient progress against individually assigned bench marks as well as against demographically similar populations. These norms and bench marks then provide a basis for determining the patient progress against what might be expected for the primary diagnosis and complicating conditions. The health care provider 332 can then make near-realtime adjustments in the disease management protocol in order to achieve better outcomes. This allows a much more discrete decision-to-action cycle whereby the health care provider has greater visibility of the health status of the patient, and can therefore, respond quickly to and adjust for changes in a day-to-day regimen.

The final or discharge assessment would allow a health care provider 332 or associated organization to determine efficacy and effectiveness of their disease management protocols. By analyzing the progress of one or more patients overall or within one or more specific diagnoses areas, a health care provider 332 or associated organization will be able to identify strengths and weaknesses of their disease management protocols and respond as necessary.

All assessment criteria are mapped and standardized on OASIS criteria for reporting compatibility. Each assessment criteria included conforms to the data definitions for the specific criteria code assignment. For example, a M0230 PRIMARY DIAGNOSIS consists of an ICD-9 code and severity index as defined in the OASIS data dictionary. This particular embodiment allows assessment data to be exported to electronic reporting software of an associated organization without need for a translation routine.

A patient care plan module 508 is adapted to provide a patient care plan for a particular user such as a patient 314 or a health care provider 332. Typically, health care providers desire a customized or tailored patient or management care plan that can include details such as, but not limited to, intensity of the management, visitation mix, frequency, and number, indicator report criteria, and assessment items for determining a patient's progress using the system 302.

The patient care plan module 508 is further adapted to assist a health care provider 332 in determining appropriate medical devices, tools, and protocols for a patient. For example, the patient care plan module 508 can create, store, and reference a management care plan from previously collected patient data. The patient care plan module 508 can then populate a schedule for a health care provider 332. Modifications to the patient care plan can be updated in realtime and linked to information associated with the patient assessment module 506. A health care provider 332 can also customize patient care plan elements previously stored in an associated database.

A series of data analysis sub-system modules 510-516 handles functionality associated with assisting a user in the management and analysis of patient management data, selecting appropriate levels of medication compliance for patients, importing and exporting data between legacy systems and the website 346, and providing secure connections for data communications between the system 302 and a third-party system or database. A data analysis module 510 is adapted to provide a user such as a health care provider 332 with at least one management and analysis tool for analyzing patient management data. For example, the data analysis module 510 can provide trend and statistical analysis tools to analyze patient data as needed. Further, the data analysis module 510 is adapted to permit import and/or export of patient data from a legacy health care information system (HCIS) as needed. Moreover, the data analysis module 510 is adapted to provide access to data in accordance with federal, state, foreign, and/or local rules or laws regarding personal and/or health care data. For example, the data analysis module 510 provides the capability to export previously collected patient data to an external tool. The data analysis module 510 can then provide integrated data management with templates and/or customized data reporting.

Next, a filter module 512 is adapted to assist a user such as a health care provider in selecting an appropriate level of medication compliance for a patient. Further, filter module 512 is adapted to determine a likelihood of a particular patient to be in full or non-medication compliance, and then to suggest an appropriate level of monitoring the patient. Moreover, the filter module 512 is adapted to provide guidance for an intensity of observation and intervention of a patient by a health care provider. In some instances, a local policy or competent health care provider can override a particular compliance level provided. For example, a health care provider 332 can utilize the filter module 512 to assess a particular patient's medication compliance level. Based upon previously received patient data, the filter module 512 can generate or otherwise calculate a likelihood of compliance for the patient as well as guidance to the health care provider 332 on monitoring the patient in accordance with a local or other policy.

Next, the import/export module 514 is adapted to provide import of patient data and/or export of patient data between a legacy health care information system (HCIS) and the website 346 as needed. The module 514 is further adapted to transfer data into the system 302 for use in enrollment of numerous patients. Moreover, the import/export module 514 is adapted to transfer data from the system 302 to legacy HCIS. For example, the import/export module 514 can handle data files, such as a “flat file” for import or export. Depending upon the particular legacy HCIS that data is imported from or exported to, customization of the import/export module 514 can be performed to adapt the module 514 to handle other types of files.

The VPN EDI (Virtual Private Network Electronic Data Interchange) module 516 is adapted to provide secure communication between the system 302 and client databases and/or legacy HCIS to facilitate data presentation and/or replication. Communications can be in secure mode compliant with local, state, foreign, or federal rules and laws. For example, the VPN EDI module 516 can provide a virtual private networking (VPN) connection with a designated client database or system using an encryption or security protocol such as 128-bit encryption security protocol. The VPN connection provides electronic data interchange (EDI) on demand from particular client databases and systems.

A series of reporting sub-system modules 518-522 handles functionality associated with assisting a user in reporting information developed in the management of at least patient, including status and efficiency of an organization associated with a health care provider; setting device filter parameters or other triggers for incoming patient data; managing delivery notification events and indicator reports for selected users such as health care providers. A reporting module 518 is adapted to provide reporting functionality for health care providers to disseminate data and other information. Further, the reporting module 518 is adapted to provide templates for displaying data. Moreover, the reporting module 518 is adapted to connect between associated assessment information and printing subsystems. In addition, the module 518 is adapted to generate OASIS compatible reporting elements and assessments. Furthermore, the reporting module 518 is adapted to permit user customization of templates for organization-specific reporting requirements.

An indicator report notification module 520 is adapted to permit a health care provider to configure device filter parameters and other triggers for incoming patient data received by the system 302. The module 520 is also adapted to allow a health care provider select a filter, or other smart agent parameters or rules for at least one medical device, and to further select a delivery destination and channels for a response. Further, the indicator report notification module 520 is adapted to generate an indicator report for a health care provider 332, and to permit the health care provider 332 select particular information for an indicator report in accordance with an established policy. For instance, the indicator report notification module 520 can deliver a report 336 via a preselected channel to the patient management module 502 for display and viewing by a health care provider 332. In at least one embodiment, a report 336 can be sent in response to a notification event such as a patient's data exceeding a preset trigger. A notification event can be stored in an associated configuration or user profile for a particular patient and/or health care provider.

An indicator report delivery module 522 is adapted to configure, control, and manage the delivery of notification events and indicator reports to respective management team members such as a group of health care providers. The module 522 is also adapted to transmit a report via facsimile, electronic mail, voice call, page, or any other wireless or wired communication mode, technique, or device. Moreover, the indicator report delivery module 522 is adapted to deliver a report based upon preset times, delivery locations, or availability of a health care provider 332. Typically, the indicator report delivery module 522 is user-configurable via a notification administration module (described below as 526) and/or configurable by a health care provider via the patient management module 502. For example, a health care provider 332 can provide delivery options regarding time, channel, and patient for a particular report 336 requested by the health care provider 332.

A series of administrative sub-system modules 524-528 handles functionality associated with allowing a user such as a local administrator to modify data associated with patients, health care providers, and medical devices in communication with the system; assist a user in setting device filter parameters and other triggers for incoming patient data; and providing a library of data protocols as needed. An administration module 524 is adapted to permit administrative users to add, modify, archive a profile for a user such as a patient 314, a health care provider 332, and/or a biological data collector 328 or medical device. The module 524 is also adapted to permit administrative users to add, modify, archive a patient care record. For instance, a local administrative user can utilize the administration module 524 to modify an existing parameter regarding a patient.

Next, a notification administration module 526 is adapted to configure, control, and manage a software agent and/or associated configuration tool to assist a health care provider in configuring a medical device or other triggers for received patient data. A software agent can be configured according to a policy, care plan guidelines and/or a prescription from a health care provider. Moreover, the notification administration module 526 is adapted to establish a notification channel for delivering a report or notification to a health care provider. For instance, the notification administration module 526 provides filters or agents that can be configured by a health care provider 332 so that an indicator report is received via predetermined delivery channel and subsequently viewed or otherwise provided by the patient management module 502.

Next, the electronic protocol database module 528 is adapted to store protocols related to disease-specific and/or skill-oriented criteria, and in some instances, including required interventions and/or objective assessment criteria oriented toward remote patient monitoring. One skilled in the art will recognize the protocols available to those implementing the electronic protocol database module 528 in accordance with the invention.

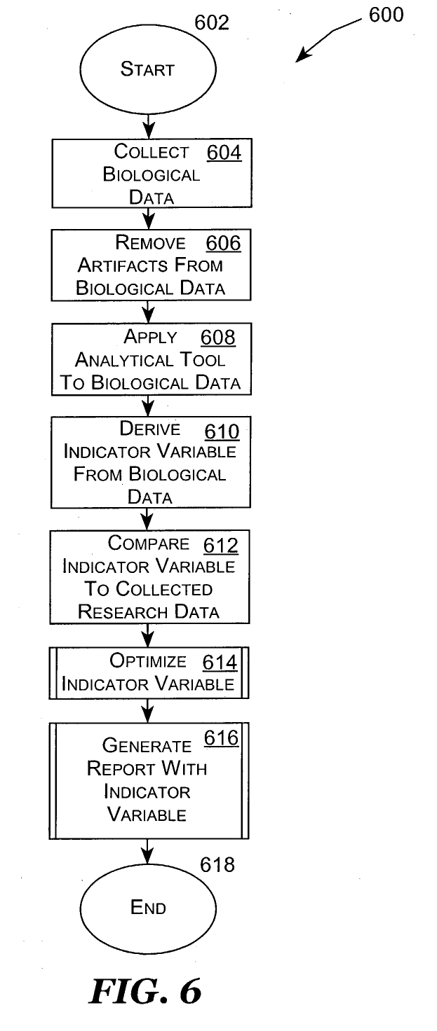

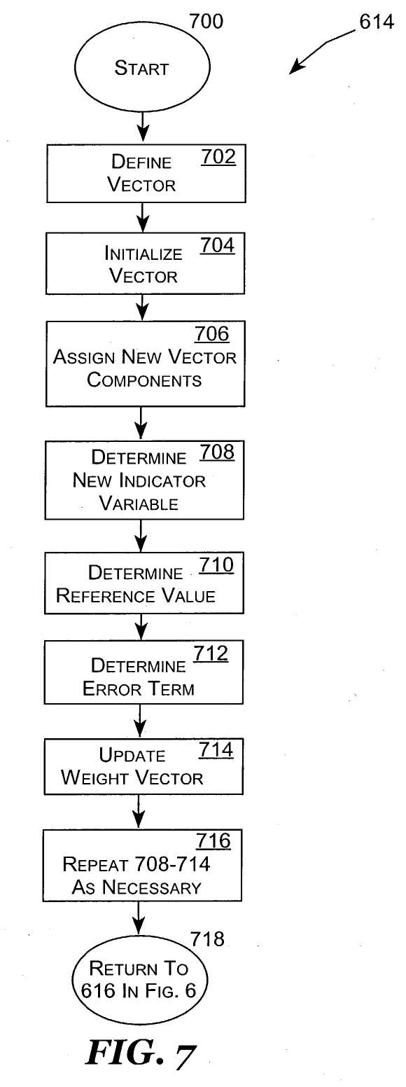

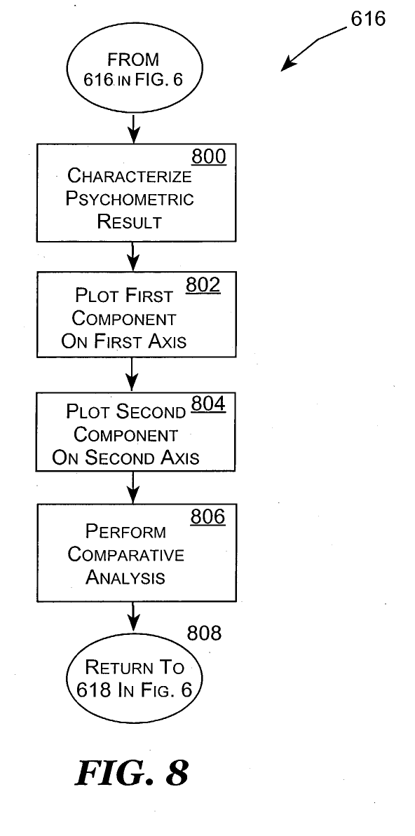

FIG. 6 is a flowchart that illustrates an exemplary method in accordance with various embodiments of the invention. The method 600 provides at least one indicator or indicator variable that adds context to a biological measurement such that interpretation by a user such as a health care provider is facilitated. The method 600 begins at 602.

602 is followed by 604, in which biological data is collected. Typically, biological data is collected from a user such as a patient in response to the patient's condition. Biological data is collected by or otherwise received by a biological data collector 328, 402 or health monitoring device 400 connected to or in communication with the patient 314, 420. The biological data can then be remotely stored by a client 318, locally at the health monitoring device 400 or biological data collector 328, or otherwise transmitted to the report generation module 306 via the network 304 for storage. In any event, the biological data can then be stored in a relevant format or useful format, such as a Lexicor file or compatible file format. Note that in most instances, demographic or other types of data can also collected and processed similar to and concurrently with the biological data as described above.

For example, attention deficit/hyperactivity disorder (AD/HD) is a condition which can be characterized by one or more indicator variables. As previously described, biological data such as QEEG data can be collected from a patient by a NRS-24 device. The NRS-24 device measures and stores QEEG signals in the patient's brain in a time-domain format. A set of spectral magnitudes or powers characterizing the measured QEEG signals from the patient can be then derived from the time-domain format by the NRS-24 device or an associated processor, and then further stored by the NRS-24 device or another device.

In another example, measurement of a brain injury is a condition that can be characterized by one or more indicator variables. Biological data such as QEEG data can be collected from a patient in a time-domain format by a NRS-24 device. Similarly a set of spectral magnitudes or powers characterizing the measured QEEG signals from the patient can be derived from the time-domain format by the NRS-24 device or an associated processor, and then stored by the NRS-24 device or another device. In most instances, realtime collected QEEG data is stored in a NRS-24 raw data format, and offline and/or processed QEEG data is stored in a NRS-24 ASP file format. One skilled in the art will recognize the various compatible file formats for these and other types of data in accordance with the invention.

Along with the biological data, other relevant data and information can be collected, such as demographic data. Data and information that is collected for a particular patient may be specific to the condition or condition being addressed. For instance when the condition is AD/HD, other relevant data can include, but is not limited to, the date of the test must be recorded, as well as the sampling rate, and demographic data such as gender, birth date, and handedness. In other instances, relevant data which might be needed for one or more “gold standard/reference (GS/R) value” comparisons includes, but is not limited to, psychometric testing results, a clinician diagnosis, patient history, and patient medication history.

604 is followed by 606, in which artifacts are removed from the collected biological data. A processor 322, 338, 352, 408 or other device can remove artifacts or otherwise unnecessary data from the collected biological data. After the biological data is received from the biological data collector 328, 402, a raw set of data is selected.

Typically, the raw set of data is selected based upon the variance of the set of data compared against the whole of the data collected. For example, from a set of QEEG data files, the processor can select a subset of these files based upon one or more parameters that show the least variance across the whole set of collected QEEG data files.

The raw data files are then pre-artifacted or artifacted using predefined criterion. Typically, collected biological data is further screened or pre-artifacted against a set of predefined thresholds or criterion. Predefined thresholds or criterion can be selected based upon an analysis of relevant biological data collected in at a prior time, or by other types of analysis. Thresholds or criterion can be an amplitude threshold, an amount of power in a particular frequency band, or otherwise derived from a raw data signal through Fourier or another type of analysis such as a Fast Fourier Transform (FFT). By further screening or pre-artifacting the collected biological data, additional or extraneous data can be excluded as artifactual when necessary with minimal or no human intervention needed.

The raw data files can be screened yet again by one or more human operators to ensure the relevancy of the collected biological data. Human operators may artifact the raw data by detecting and recognizing complex pattern activities known to those skilled in the art. In some instances, pre-artifacting and/or artifacting can be performed manually, while in other instances, the pre-artifacting or artifacting can be automated. In any event, the screened set of biological data can then be stored in a memory storage device such as an archive database 340 for further processing.

For example, a set of collected QEEG data files from a NRS-24 device may be filtered, screened, pre-artifacted, or otherwise artifacted by a processor 322, 338, 352, 408 to obtain a particular set of data files based upon a predetermined criteria or threshold such as time domain and/or spectral (power or magnitude). Other criteria or thresholds may be used to filter, screen, pre-artifact, or artifact data depending upon the quality and nature of the collected data. The obtained set of QEEG data files may then be further filtered, screened, pre-artifacted, or otherwise artifacted by the processor and/or manually artifacted by one or more human operators depending upon the quality and nature of the obtained set of data. Note that the data that is filtered, screened, pre-artifacted, or otherwise artifacted can include biological data, demographic data, and other collected data associated with a patient or patient's health condition.

606 is followed by 608, in which one or more analytical tools are applied to the biological data. Typically, a processor 322, 338, 352, 408 applies an analytical tool 354 to a particular set of collected biological data and/or other collected data. The analytical tool 354 generally includes an algorithm. When the algorithm is applied to the biological data, at least one indicator variable can be derived from the data. Indicator variables, or indicators, are relevant for interpretation of a particular condition. In most instances, at least one indicator variable is selected based upon an indicator variable's ability to discriminate between a normal subgroup and a population subgroup affected by the particular condition. In some instances, more than one analytical tool can be applied to the biological data. Analytical tools 354 and associated algorithms can utilize techniques including, but not limited to, mathematical transformations, filtering, screening, pre-artifacting, and artifact removal. Relevant formats are achieved by techniques including, but not limited, to mathematical transformations, or a format appropriate for comparison against a known quantity facilitating interpretation of a particular set of biological data. Indicator variables may be selected from results of analysis, advice from a scientific advisory board, and/or judgment from one or more researchers.

608 is followed by 610, in which at least one potential indicator variable is selected or derived from the raw data. An indicator variable can then be used by the system 302 to monitor a patient with respect to a particular health condition or issue. Typically, the collected and screened biological data will have one or more potential indicator variables. These potential indicator variables can be selected either manually or by automation. In general, potential indicator variables will show relatively minimal variance or no variance across most of the artifacted data files within a particular sub-group or category.

For example, indicators such as the “theta/beta ratio” and “frontal beta power” can be derived for a health condition such as AD/HD. Both indicators can be characterized by QEEG data including time domain and spectral (power or magnitude) domain components. If the health condition being addressed is a brain injury, these and other indicators including a range of quantitative variables can be used to characterize the health condition. In any instance, a set of thresholds in the time and spectral (power or magnitude) domains can be selected for comparison against collected biological data.

610 is followed by 612, in which the indicator variable is compared to collected research data. Typically, a processor 338, 352 compares an indicator variable to previously collected research data from at least one data source. Generally, a meta-analysis is performed by the report generation module 308 and/or research analysis module 310 to determine the data to compare the indictor variable to. A meta-analysis typically includes a review of the body of relevant scientific literature from one or more data sources, such as 356-360. Electronic sources can be utilized with key word searches to access journal abstracts. Related journal articles can be gathered from on-line sources, libraries, and ordering when necessary. Reference lists from the gathered articles are examined for further articles. Standard textbooks and reference books are consulted for review. On-line and printed sources of statements of committees and boards are examined. Effect sizes of one or more indicators can be determined. Data sources that can be used for comparison against the indicator include, but are not limited to, normative databases, clinical databases, databases of the disorder in question, databases of other disorders, research-based cut-offs for a disorder, research-based patterns of variable outcomes for a disorder, research-based concepts, accepted gold standards of diagnosis, and other data sources with indicator variables.

For example, variables selected from processed QEEG data, such as theta/beta ratio and frontal beta power, can be compared to data interpretation tools derived from previously collected research data. The theta/beta ratio is compared against a published cutoff demonstrated to indicate AD/HD. The theta/beta ratio is compared against a published pattern for theta/beta ratio attenuation with age. The theta/beta ratio is put in the context of known classification accuracy results for AD/HD using the theta/beta ratio. The frontal beta power is compared against a normative database. The frontal beta power is compared against accepted statistical cutoffs for abnormality. The frontal beta power is put in the context of known distributions of AD/HD subjects amongst theta/beta ratio and frontal beta power changes.

Note that a published cutoff for theta-beta ratios is at values 1.5 standard deviations greater than the mean theta-beta ratio for normal control subjects. Further, a published pattern for theta-beta ratios is that there is a relative decline in the difference of the theta-beta ratio compared between AD/HD and normal subjects. Known results and distributions can be provided by scientific and research journals or other research sources, and can provide detailed analysis such as, “Of those children determined to have AD/HD by this standard diagnostic protocol in one study, 90% were correctly classified using the theta/beta ratio in what was effectively a repeated measures design. Ninety-four percent (94%) of the non-AD/HD children were also correctly identified by this scheme. In an associated study, 86% sensitivity and 98% specificity were observed.” Finally, accepted statistical cutoffs can be provided by similar types of sources, and can provide detailed knowledge such as, “An individual with a frontal beta power 1.96 standard deviations difference from the mean the frontal beta power of the normal population translates to a probability of less than 5% that the individual belongs to the normal population. A probability of less than 5% is the standard upheld by peer reviewed scientific journals for the demonstration of a statistical difference.”

In the instance when a range of quantitative variables are derived for a patient with a brain injury, the variables are compared to a normative database. A single variable may be produced using a discriminant equation. The discriminant equation can be based upon published research and/or in-house research comparing selected and weighted QEEG variables of normative and mild traumatic brain injury databases. The discriminant variable is then compared against a cutoff demonstrated to indicate a predetermined amount of brain injury.

In any instance, depending upon the comparison results with existing research, cutoffs, or other data, one or more of the indicator variables can be modified or otherwise adjusted as needed.

In the example above, meta-analysis for the selected variables included searches of relevant scientific literature and electronic databases or sources such as MEDLINE. Relevant terminology associated with relevant keywords such as “AD/HD” and “electroencephalography” can be sought in titles, abstracts, and manuscript keywords of various literature, databases, and sources. Searches can also be limited in time, such as emphasizing studies published from 1998 to 2002. Furthermore, the research can adhere to specific predefined guidelines such as the American Academy of Pediatrics (AAP) guidelines for AD/HD assessment which provides an outline for AD/HD diagnostic schemes.

Moreover, brain electrical changes associated with AD/HD were summarized for each research study in terms of significant changes to general QEEG variables. When possible, the effect size of the QEEG result was calculated, and compared against AAP-accepted behavior rating scales. In addition, the effectiveness of brain electrical activity as an adjunctive diagnostic tool for AD/HD was reported in terms of: (1) relative risk, compared against genetic and environmental factors; (2) classification accuracy, compared against general medical diagnostics; and (3) classification agreement with clinicians, compared against AAP recommended evaluative tools. The age decline of behavioral symptoms of AD/HD was summarized by a mathematical model and graphically compared against the age-decline of the brain electrical pattern for AD/HD.

612 is followed by subroutine 614, in which an indicator variable is optimized. Generally, optimization of at least one indicator variable is accomplished by selecting one or more indicator variables that are least affected by different raw artifacting styles, processes, and/or devices. Typically, a processor 338, 352 selects or otherwise optimizes an indicator variable. Other criteria for optimizing or selecting one or more indicator variables can be used. Furthermore, optimization of one or more indicator variables can be performed by (1) incorporating additional data into the generation, selection, or improvement of a particular indicator variable, wherein the data can be collected from one or more data sources such as data from multiple patients, research databases, and in-house databases; and (2) implementing an analytical scheme to generate, select, or improve a particular indicator variable, such as applying a discriminant equation, compiling a gold standard/reference value, or adjusting a previously determined discriminant equation to an indicator variable.

For example, for previously collected QEEG data, optimizing an indicator variable allows for the generation, selection, or improvement of a QEEG-based indicator which will complement or replace a set of psychometrics or other independent measures used to discriminate subjects with a particular mental health condition from normals. Furthermore, optimization provides for the optimization of the above indicator variable, generated from QEEG derived parameters. Various QEEG derived parameters can relate to general categories of data such as demographics, diagnostics, genetics, and psychometrics. Demographic-related data can include, but is not limited to, age, sex, handedness, time of day, diet, sleep, lifestyle, geographic, environmental, social history, and the like. Diagnostic-related data can include, but is not limited to, DSM-IV categories and sub-categories, blood tests, positron emission tomography (PET), single photon emission computerized tomography (SPECT), magnetic resonance imaging (MRI), functional magnetic resonance imaging (fMRI), and other types of data that health care providers can use to make a diagnosis of a health condition. Genetic-related data can include, but is not limited to, presence and/or absence of any of the following: markers, alleles, haplotypes, and any other data associated with a human gene. Psychometric-related data can include, but is not limited to, intelligence quotient (IQ), performance tests, other tests that characterize an aspect of human behavior. Those skilled in the art will recognize that these types of data, and similar types of data can be used to optimize one or more indicator variables and/or components of a particular indicator variable in accordance with the invention. An exemplary optimization subroutine is further described below with respect to FIG. 7.

Subroutine 614 is followed by subroutine 616, in which a report is generated for one or more indicator variables determined in 610-614. Typically, processor 338 of the report generation module 308 generates the report 336 for transmission to a user 314, 332. A report 336 typically includes one or more data interpretation tools that present one or more indicators or indicator variables for analytical interpretation. For example, an exemplary data interpretation tool displays a graphical view of one or more conditions for a particular patient, with a condition being characterized by one or more indicator variables. A data interpretation tool can include, but is not limited to, a graph or a chart. Generation of a report and associated data interpretation tool is further described below in FIG. 8.

Subroutine 616 is followed by 618, in which the method 600 ends.

FIG. 7 is a flowchart that illustrates another exemplary subroutine of the method in FIG. 6. FIG. 7 illustrates an optimization subroutine for indicator variables associated with AD/HD. This procedure can be generalized up to as many components (or dimensions) of the psychometric as desired by adding adaptive filters, linear predictive filters (LPFs), gold standard/reference (GS/R) components, or combinations of various filters and gold standard ratio components. One skilled in the art will recognize the applicability of this and similar subroutines to other indicator variables in accordance with the invention. For example, in at least one embodiment, a linear predictive filter (LPF) such as a least mean square (LMS) adaptive filter, and one new GS/R component can be used for each new QEEG-based indicator component desired. Thus, QEEG-based indicators, such as Ia, Ib, Ic, etc., could be generated and displayed in a graphical format, which would allow for more precise differentiation between normal and abnormal population sub-groups.

Linear predictive filters (LPFs) can be trained and optimized off line with a training set comprised of a set of associated psychometric and QEEG data sets. The LPFs can also be used to further optimize and update each QEEG-based indicator as each new QEEG/psychometric data set becomes available.

In some instances, LPFs permit individual or clusters of QEEG derived parameters including one or more indicator variables to be improved, modified, or otherwise weighted to replace individual or clusters of non-QEEG derived gold standard/reference values or other reference-type data. Subroutine 614 begins at 700.

700 is followed by 702, a vector is defined. For example, for indicator variables associated with AD/HD, a weight and an indicator component (IC) vector can be defined, with each vector having a length L. The IC vector can be a vector containing relevant or useful formatted biological data, such as at least one derived QEEG component that has been demonstrated to be relevant for the generation of an indicator variable.

702 is followed by 704, in which a weighting vector is initialized. For example, the weight vector is initialized with random numbers, such as numbers between “−1” and “+1.”

704 is followed by 706, in which newly derived indicator components are assigned to a vector. For example, each time a new patient data record is obtained, at least one derived QEEG component is computed and placed in the IC vector.

706 is followed by 708, in which a new indicator variable is determined. For example, an indicator variable is computed by multiplying each element of the weight vector by the corresponding element of the IC vector. The sum of these multiplications is then computed to result in the value “IC.”

708 is followed by 710, in which a reference value is determined. For example, from a set of predetermined psychometric gold standard/reference data, a value can be computed. The value can then transformed to a reference value ranging between “−1” and “+1”.

710 is followed by 712, in which an error term is determined. For example, an “error_term” is computed by subtracting the reference value from the computed indicator variable.

712 is followed by 714, in which the weight vector is updated. For example, the weight vector is updated as follows. For each element “i” of the L element weight vector: weight[i]=weight[i]−(Update_factor * error_term * IC[i])

714 is followed by 716, in which 708-714 are repeated as necessary. As an example, when 706-712 are repeated continuously, a QEEG indicator variable is produced which converges to the gold standard/reference value, assuming the following: (1) The gold standard/reference value is an independent measure from the QEEG; (2) the population subset upon which the particular indicator is based is homogeneous in the sense that the QEEG derived from members of that subset are more like each other, than they are to a normative set; (3) the psychometric measures defined for the population subset in question can be used to discriminate the mental health condition from normal; and (4) the update-factor is selected (by experimentation) to be large enough to allow the linear predictive filter to converge in a reasonable amount of time, and small enough to guarantee the stability of the optimization process. Note that the above describes the generation and optimization of a one-dimensional indicator value which can then be compared to a one-dimensional gold standard/reference value from which an error term is derived, which is then used to optimize the linear predictive filter weights, which in turn cause the output of the linear predictive filter to converge to the gold standard/reference value over time.

714 is followed by 716, in which the subroutine returns to 614 in FIG. 6.

Note that one skilled in the art will recognize the applicability of the subroutine 614 to one or more indicators or indicator variables. In any subroutine utilized to optimize one or more the indicator variables, multiple components or dimensions of a particular psychometric can be analyzed as desired. Each added component or dimension would require a respective linear predictive filter such as a LMS adaptive filter, and a respective reference value such as a gold standard/reference (GS/R) component for each indicator variable desired. Thus in this manner, multiple indicator variables could be generated, such as Ia, Ib, Ic, etc., and displayed in a graphical format similar to that illustrated in FIGS. 10A and 10B. This type of formatting would permit improved differentiation between normal and abnormal population subgroups. Further, each respective filter can be trained and optimized “offline” with a training set of associated psychometric and relevant data sets, such as QEEG data. Each of the filters can also be used to further optimize and update each indicator variable as new psychometric or relevant data becomes available.

FIG. 8 is a flowchart that illustrates another exemplary subroutine of the method in FIG. 6. FIG. 8 illustrates an exemplary subroutine 616 to generate a report and associated data interpretation tool described above in FIG. 7. The subroutine 616 describes the generation of a report with at least one data interpretation tool associated with an indicator variable determined from 610-614. One skilled in the art will recognize that this and other types of report generation can be applied to various indicator variables in accordance with the invention.

Subroutine 616 begins at 800, in which a psychometric result is characterized by at least two components. For example, in some instances, a psychometic result can be broken down into two components or parameters, X and Y. Typically, a psychometric result is associated with the determination of one or more indicator variables from 610-614 in FIG. 6.

800 is followed by 802, in which a first component is plotted on a first axis. For example, a parameter X can be plotted along a first or X (horizontal) axis.

802 is followed by 804, in which a second component is plotted on a second axis. For example, a parameter Y can be plotted along a second or opposing Y (vertical) axis.

804 is followed by 806, in which a comparative analysis is made. For example, using the X and Y plots from 802 and 804, a classification of a particular subject or patient as normal or abnormal can be determined within a particular region rather than along a line as in a uni-dimensional case. In this example, multi-dimensional QEEG indicators can be determined and analyzed.

Generally, at least one filter is used to generate an optimized QEEG-based indicator for a first or x component, Ix. Typically, a weight vector can be utilized to minimize the error term between Ix and Rx, the reference variable or gold standard/reference against which Ix is compared. Then, a second filter can be used to generate an optimized QEEG indicator for the y component, Iy. Again, using a weight vector update rule, the error term between Iy and the corresponding Ry, the reference variable or gold standard/reference against which Iy is compared, can be minimized. The components Ix and Iy, can then be plotted on a two-dimensional grid, thus allowing regions of normality and abnormality to be identified or classified in a two dimensional space rather than a classification in one dimension along a line.

806 is followed by 808, in which the subroutine 616 returns to 618 in FIG. 6.

Note that in any subroutine utilized to generate a report for one or more the indicator variables, multiple components or dimensions of a particular psychometric can be displayed as desired. Each added component or dimension would require a respective filter such as a LMS adaptive filter, and a respective reference value such as a gold standard/reference (GS/R) component for each indicator variable desired. Thus in this manner, multiple indicator variables could be generated, such as Ia, Ib, Ic, etc., and displayed in alternative graphical formats. This type of formatting would permit improved differentiation between normal and abnormal population subgroups. Further, each respective filter can be trained and optimized “offline” with a training set of associated psychometric and relevant data sets, such as QEEG data. Each of the filters can also be used to further optimize and update each indicator variable as new psychometric or relevant data becomes available.

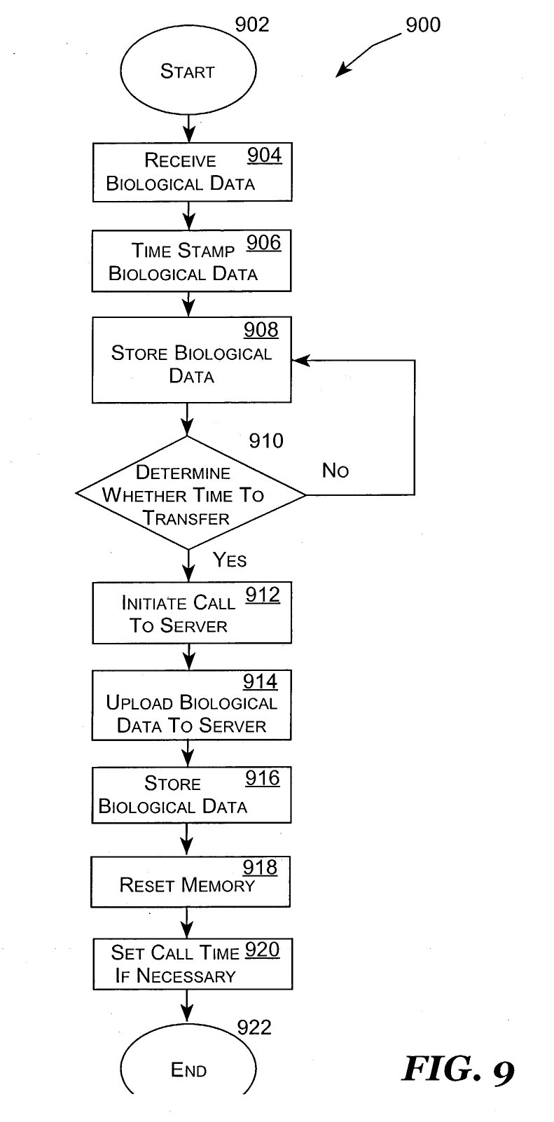

FIG. 9 is a flowchart that illustrates another exemplary method in accordance with various embodiments of the invention. The method 900 in FIG. 9 facilitates collection of biological data from a biological data collector such as a medical monitor, transfer of the data via a network, and subsequent storage of the biological data in a memory or similar type of storage device. One skilled in the art will recognize similar methods, techniques, and devices applicable to collecting, transferring, and storing biological data in accordance with the invention.

The method 900 begins at 902.

902 is followed by 904, in which biological data is received. Typically, biological data is collected or otherwise received from at least one biological data collector 402 or medical device in communication with a patient 420. Data is transmitted to a respective processor 410 for processing. In some instances, the data is transmitted and collected or otherwise received in the core processor 408 associated with the health monitoring device 400.

904 is followed by 906, in which the biological data is time stamped. Generally, as the data is acquired by the core processor 408, the core processor 408 stamps or associates the data with information from a time/date or clock chip.

906 is followed by 908, in which the biological data is stored. The time stamped data is then stored in a memory 412 such as a non-volatile flash memory.

908 is followed by decision block 910, in which a determination is made whether the current time is a predetermined time to transfer the data. Typically, the core processor 408 determines whether a time from the date/time chip corresponds to a predetermined “CALL-TIME” stored in the memory 412. If the time corresponds, then the “YES” branch is followed to 912.

In 912, a call is initiated to the server. That is, whenever the core processor 408 determines that the date/time chip time matches a stored “CALL-TIME” in the memory 412, the health monitoring device 400 initiates a call to the server 404 over the network 406.

912 is followed by 914, in which biological data is uploaded to the server. Once the modem 418 establishes a communication link with the server 404 and/or associated modem (not shown). Typically, the server 404 verifies and authenticates the user associated with health monitoring device 400, and then the server 404 uploads all biological data from the memory 412 of the health monitoring device 400 since an immediately prior communication session with the server 404.

914 is followed by 916, in which the biological data is stored by the server. The server 404 can then store the biological data in an associated memory or storage device as a text file, such as in a Lexicor file format. For example, the server 404 can transmit the file to another server associated with the network 406, or can otherwise store the file in a memory or storage device associated with either server. The text file may then be called upon by the server 404 in a subsequent transaction such as a DTS (Data Transformation Service) transaction that transmits the data to an associated database (not shown) such as a SQL database.

916 is followed by 918, in which the memory is reset. After all data from the health monitoring device 400 is transmitted to the server 404, the server 404 sends a command to the health monitoring device 400 which results in a pointer associated with the memory 412 of the health monitoring device 400 being reset to zero. This permits the data which has been uploaded to the server 404 to be overwritten in the memory 412 by subsequent data acquired from a biological data collector 402 or a medical monitor.

918 is followed by 920, in which a call time is set. Optionally, while the health monitoring device 400 and server 404 are communicating, the server 404 can reset one or more of the “CALL-TIMES” in memory 412. This provides the ability to field re-program the health monitoring device 400, in addition to the remotely resetting the pointer in memory 412. In other embodiments, other timers, pointers, and associated memory registers may be re-programmed as needed.

920 is followed by 922, in which the method 900 ends.

Returning to decision block 910, if the core processor 408 determines that the time from the date/time chip does not correspond to a predetermined “CALL-TIME” stored in the memory 412, then the “NO” branch is followed back to 908, where the method 900 continues.

FIGS. 10A-10B illustrate an exemplary report generated in accordance with various embodiments of the invention. Typically, a report 1000 is generated by the report generation module 306 of the system 300 illustrated in FIG. 3. Other modules of the system 300 may generate a report in accordance with various embodiments of the invention. A report 1000 includes an identifying section 1002, a findings section 1004, a background section 1006, terminology section 1008, and a references section 1010. The various sections 1002-1010 can be organized in alternative configurations depending upon the intended use of the data in the report.

The identifying section 1002 includes the name of the report and patient identifying information such as patient name, patient identification number (ID), gender, age, date of test, and known medications the patient is taking, and other demographic or identifying data. In the example shown, the report 1000 is titled “Attention Deficit/Hyperactivity Disorder (AD/HD) Indicator Report.” The identifying section also includes the source of the testing and/or report data, as well as the referring doctor or health care provider's contact information. Furthermore, the identifying section 1002 includes a procedural description of how a particular test or assessment was performed. For example, in the report shown, a neuroassessment was performed on a patient. The identifying section 1002 provides general details on the testing equipment used to collect biological data on the patient, and the database used for analyzing the patient's biological data.

The findings section 1004 generally includes at least one indicator variable and associated data interpretation tool. In the example shown, a theta-beta ratio indicator variable 1012 and graphical chart 1014 are illustrated. A value 1016 for the theta-beta indicator variable is shown as “4.56.” The graphical chart 1014 shows an age vs. theta-beta ratio distribution for a normal (or mean) population 1018, and a comparative theta-beta ratio distribution 1020 for a particular patient. In this example, the theta-beta ratio for a particular patient exceeds the theta-beta ratio distribution for the normal (or mean) population. A health care provider could utilize this type of data to support an analysis and/or conclusion that the patient tests “positive” in a complete assessment for the particular condition tested for, such as AD/HD.

Furthermore, the findings section 1004 illustrated in FIG. 10A shows a frontal power indicator variable 1022 and associated graphical chart 1024. A value 1026 for the frontal power indicator variable is shown as “−1.10.” The graphical chart 1024 shows a Z-score frontal power distribution for a normal (or mean) population 1028, and a comparative Z-score frontal power distribution 1030 for a particular patient. In this example, the Z-score frontal power distribution for a particular patient does not exceed the Z-score frontal power distribution for the normal (or mean) population. A health care provider could use this type of data as a complement to a complete assessment protocol to support that the patient tests “negative” for the particular condition tested for, such as a subset of combined AD/HD patients with an abnormal Z-score for frontal power.

Interpretive information for guiding a health care provider's analysis can also be provided in the findings section 1004. For example, general observations about a particular indicator variable with respect to the normal (or mean) population can be provided.

As shown in FIG. 10B, the background section 1006 generally includes a summary of research results for each indicator variable presented in the findings section 1004. In this example, a research summary 1032 for the theta-beta ratio indicator variable provides guidance for a user to evaluate the respective data in the findings section. Likewise, another research summary 1034 for the frontal beta indicator variable provides guidance for a user to evaluate the respective data in the findings section.

Typically, the terminology section 1008 provides definitions associated with each indicator variable as shown in FIG. 10B. Information associated with past or present research can be presented in this section to provide guidance to health care providers that may be familiar with some or all of the state of the art research in a particular field.

In the references section 1010, various research articles, documents, or previously published information related to a particular patient's condition are provided. In most instances, a citation to the author, journal or publication, title of the article or document, page cite, and date is provided.

Note that other relevant information may be provided in a report 1000. Relevant information can include, but is not limited to, patient identifying information such as demographic data, health care provider reference information, report provider or vendor, procedural information related to generating the indicator variables, interpretive information related to each indicator variable, links to related topics associated with a particular condition or indicator variable addressed.

As described in 612 of FIG. 6, a meta-analysis is performed to previously collected research data to compare one or more potential indicator variables to accepted standards. The following method 1100 describes an exemplary method for gathering research and determining one or more indicators. One skilled in the art will recognize similar methods, devices, and routines that can be used for gathering research and determining indicators in accordance with the invention.

The method 1100 begins at 1102.

1102 is followed by 1104, in which a determination is made to address a health condition. For example, a health condition can include a disorder such as AD/HD.

1104 is followed by 1106, in which an extensive review of relevant scientific research is performed. Typically, relevant abstracts are searched and reviewed. Search and selection criteria can include, but are not limited to, the ability to make a classification using particular biological data such QEEG; consistency in the literature with a particular pattern, such as a QEEG pattern, associated with the health condition or disorder, history of a particular researcher and respective contributions to the field; general acceptance of collection and analysis techniques with this disorder based upon multiple research groups in the field, or clinics and other applied settings, or boards, committees, and other organizations reviewing this disorder.

1106 is followed by 1108, in which relevant scientific articles are reviewed. For example, relatively important scientific articles are gathered and selected. The selection basis can include, but is not limited to, complete critical analysis of the content. Content can include methods, e.g. appropriate clinical assessment scheme for the disorder; experimental design for the analyses performed, e.g. sufficient sample size for type of analysis; results, e.g. proper testing of validity, reliability, and classification accuracy; discussion and conclusion, e.g. no fatal flaws in the logic; and overall impression of integrity, competence, and scientific standards of the research group.

1108 is followed by 1110, in which one or more patterns are conceptualized within the research. Pattern conceptualization can include, but is not limited to, determining any contradictions between studies, and look for causal factors such as discrepancies in experimental design or analyses; determining one or more variables and/or equations that capture potential patterns in the research; determining one or more variables and/or equations that require further development.

1110 is followed by 1112, in which a characterization scheme is determined for the health condition. Typically, a characterization scheme is based upon patterns and analysis of the patterns using an associated battery of clinical assessment tools. For example, the characterization scheme can be defined by one or more of the following determining the manner in which a disorder can be addressed, as limited by the information within the data; elucidating limits of the characterization scheme; formulating means of addressing the limits, e.g. using explicit report text and graphics, devising a combination of variables, and developing future experimental designs.

1112 is followed by 1114, in which a report is designed. Designing a report includes, but is not limited to, verbalizing one or more associated messages of the report based on the characterization scheme; formally selecting one or more variables and verify validity within body of research; designing graphical images to convey the scientific context of selected research studies in a relatively simple fashion; designing the report text to succinctly draw focus to the characterization scheme and related background and support, as well as limitations; including appropriate research and resource references; organizing a structured report layout.

1114 is followed by 1116, in which the report is reviewed prior to release. Typically, one or more human operators engage in proofreading the report and making any revisions. Human operators can include medical and/or scientific advisors.

1116 is followed by 1118, in which the report is updated. Prior to or after release of the report, a report can be updated with the advent of one or more new indicators. This process permits the report to be continuously updated as needed or required. Revise report design with advent of new indicators. Typically, new research articles are continually researched for one or more new indicators. Other unique indicators can be developed using in-house and collaboration data, and/or driven by experimental designs originating from the report limitations.

1118 is followed by 1120 in which the method 1100 ends.

While the above description contains many specifics, these specifics should not be construed as limitations on the scope of the invention, but merely as exemplifications of the disclosed embodiments. Those skilled in the art will envision many other possible variations that within the scope of the invention as defined by the claims appended hereto.

The invention we claim is:

1. A method for managing a patient's biological data and providing a data interpretation tool for the biological data via a network, comprising:
collecting biological data from a patient;
transmitting a portion of the biological data through the network to a storage device;
determining at least one potential indicator variable associated with the patient's biological data;
comparing the at least one potential indicator variable associated with the patient's biological data to a standardized set of data associated with a health condition;
based upon the comparison, selecting at least one indicator variable; and
generating a report including the indicator variable and at least one data interpretation tool to a health care provider associated with the patient.

2. The method of claim 1, further comprising:
optimizing at least one selected indicator variable, wherein the optimized indicator variable provides an improved comparison over the originally selected indicator variable for comparing a patient's biological data to a standardized set of data associated with the health condition.

3. The method of claim 2, wherein the optimizing at least one selected indicator variable, further comprises:
determining a vector for the selected indicator variable;
based upon new data, updating the vector for the selected indicator variable; and
determining a new indicator variable.

4. The method of claim 1, wherein collecting biological data from a patient comprises at least one of the following types of data: blood pressure, weight, a blood component measurement, a bodily fluid component measurement, body temperature, a heart measurement, a brain wave measurement, another measurement associated with a biological function, or another measurement associated with a physiological function.

5. The method of claim 1, wherein collecting biological data from a patient comprises:
transforming the collected biological data into a set of corresponding time and spectral data.

6. The method of claim 5, wherein the transformation applies at least one of the following: Fourier analysis, Fast Fourier Transform, a statistical analysis, or a mathematical transformation.

7. The method of claim 1, wherein determining at least one potential indicator variable associated with the patient's biological data comprises:
based upon the variance of the biological data for a set of potential indicator variables, selecting at least one potential indicator variable from the set of potential indicator variables.

8. The method of claim 1, wherein the standardized set of data associated with a health condition comprises a predetermined indicator that is indicative of a health condition.

9. The method of claim 1, wherein the standardized set of data associated with a health condition comprises data from at least one of the following: an in-house database, a public research database, a normative database.

10. The method of claim 1, wherein comparing the at least one potential indicator variable associated with the patient's biological data to a standardized set of data associated with a health condition comprises:
applying an analytical tool to the indicator variable and standardized set of data associated with the health condition, wherein the analytical tool comprises at least one of the following: statistical analysis, neural network, learning machine, or judgment scheme.

11. The method of claim 1, wherein the data interpretation tool comprises at least one of the following: a graph, a chart, a comparative analysis, a statistical analysis.

12. The method of claim 1, wherein generating a report including the at least one selected indicator variable and at least one data interpretation tool to a health care provider associated with the patient comprises formatting the report with the at least one selected indicator variable, data interpretation tool, and at least one research source.

13. A method for determining an indicator variable for a patient's health condition, comprising:
receiving biological data from a patient;
artifacting the patient's biological data;
applying an analytical tool to the patient's biological data to determine at least one potential indicator variable;
comparing at least one potential indicator variable to at least one predetermined indicator associated with a health condition; and
based upon the comparison, selecting an indicator variable to characterize the patient's health condition.

14. The method of claim 13, further comprising:
optimizing the selected indicator variable, wherein the optimized indicator variable provides an improved comparison over the originally selected indicator variable for comparing a patient's biological data to other data associated with the health condition.

15. The method of claim 14, wherein the optimizing the selected indicator variable, further comprises:
determining a vector for the selected indicator variable;
based upon new data, updating the vector for the selected indicator variable; and
determining a new indicator variable.

16. The method of claim 13, wherein receiving biological data from a patient comprises:
transforming the received biological data into a set of corresponding time and spectral data.

17. The method of claim 16, wherein the transformation applies at least one of the following: Fourier analysis, Fast Fourier Transform, a statistical analysis, or a mathematical transformation.

18. The method of claim 13, wherein artifacting the patient's biological data comprises:
based upon at least one predetermined threshold, filtering the patient's biological data.

19. The method of claim 18, wherein the predetermined threshold comprises at least one of the following: a time domain, a spectal power, a frequency magnitude, or a frequency power.

20. The method of claim 13, wherein applying an analytical tool to the patient's biological data to determine at least one potential indicator variable, comprises:
determining a variance of a portion of the patient's biological data with respect to at least one potential indicator variable; and
selecting at least one potential indicator variable that displays a lesser variance over a portion of the patient's biological data.

21. The method of claim 13, wherein the at least one predetermined indicator comprises a standardized set of data associated with a health condition.

22. The method of claim 21, wherein the standardized set of data associated with a health condition comprises data from at least one of the following: an in-house database, a public research database, a normative database.

23. The method of claim 13, wherein comparing at least one potential indicator variable to at least one predetermined indicator associated with a health condition comprises:
applying an analytical tool to the potential indicator variable and predetermined indicator associated with the health condition, wherein the analytical tool comprises at least one of the following: statistical analysis, neural network, learning machine, or judgment scheme.

24. The method of claim 23, further comprising:
based upon a correlation of the potential indicator variable to the predetermined indicator associated with a health condition,
selecting a data interpretation tool for a report; and
transmitting the selected data interpretation tool and at least one indicator variable to a user.

25. The method of the claim 13, further comprising:
receiving additional biological data from the patient; and
based upon a portion of the additional biological data, optimizing the selected indicator variable.

26. A method for managing research data for comparison with collected biological data of a patient, comprising:
selecting a health condition;
receiving research from at least one data source, wherein the research is associated with the health condition;
analyzing the research to determine at least one aspect of the health condition; and
characterizing the aspect of the health condition with at least one indicator, wherein the indicator can be compared with at least one potential indicator variable associated with a particular patient's biological data.

27. The method of claim 26, wherein the data source comprises at least one of the following: an in-house database, a research database, or a normative database.

28. The method of claim 26, further comprising:
optimizing the indicator with new data from at least one data source, wherein the optimized indicator can be compared with at least one potential indicator variable associated with a particular patient's biological data.

29. A system for managing a patient's biological data and providing a data interpretation tool for the biological data via a network, comprising:
a data collection module, comprising:
a biological data collector adapted to collect biological data from a patient;
a network interface adapted to receive biological data from the data collector, and further adapted to transmit the biological data via the network to a storage device; and
a report generation module, comprising:
a processor-based device adapted to,
receive the patient's biological data from the biological data collector;
determine at least one potential indicator variable from a portion of the patient's biological data;
compare the biological data to a standardized set of data associated with a health condition;
select at least one potential indicator;
generate a data interpretation tool adapted to analyze the selected indicator variable; and
transmit a report with the data interpretation tool and selected indicator to a user via the network; and
a storage device adapted to store the patient's biological data, potential indicator variables, and any selected indicator variables.

30. A system for determining an indicator variable for a patient's health condition, comprising:
a research analysis module, comprising:
a processor adapted to,
collect relevant research for at least one health condition;
determine at least one indicator for the health condition;
a report generation module, comprising:
a processor adapted to,
receive biological data from a patient;
artifact the patient's biological data;
apply an analytical tool to the patient's biological data to determine at least one potential indicator variable;
compare at least one potential indicator variable to the predetermined indicator associated with the health condition; and
based upon the comparison, select at least one indicator variable to characterize the patient's health condition.

31. A system for managing research data for comparison with collected biological data of a patient, comprising:
a research analysis module adapted to,
select at least one health condition;
receive research from at least one data source, wherein the research is associated with the health condition;
analyze the research to determine at least one aspect of the health condition; and
characterize the aspect of the health condition with at least one indicator, wherein the indicator can be compared with at least one potential indicator variable associated with a particular patient's biological data.
